(19) United States
(12) Patent Application Publication
(10) Pub. No.: US 2009/0029754 A1
(43) Pub. Date: Jan. 29, 2009

(54) Tracking and Interactive Simulation of Real Sports Equipment

(75) Inventors: Adam Slocum, New York, NY (US); Robert Kennett, Bedford, NH (US)

Correspondence Address: Leon Fortin Jr., 44 Lantern Lane, Sharon, MA, 02067, US

(73) Assignee: CYBERSPORTS, INC, New York, NY (US)

(21) Appl. No.: 12/178,545

(22) Filed: Jul. 23, 2008

Related U.S. Application Data
(60) Provisional application No. 60/951,245, filed on Jul. 23, 2007.

(51) Int. Cl. G06F 17/00

(52) U.S. Cl. 463/5; 463/32

(57) ABSTRACT

A real-ball interactive sports entertainment and training system combines real-time motion sensing of real world sports equipment to create simulated interactions with amateur or professional sports figures on-screen, optionally including in-game advertising. The interactive sports entertainment and training experience extends to the internet, where users can view their statistics and highlights and compare notes and simulated sports stories with other users, or “cyberjocks.” The system implements methods that include embedding a plurality of three-axis motion sensors within a single piece of user sports equipment, wherein each of the plurality of sensors provides a continuous stream of relative motion data for each axis; disposing the plurality of three-axis motion sensors so that none of the axes are aligned; connecting the disposed motion sensors to a processor, and powering the sensors and the processor so that the processor receives the relative motion data; converting the relative motion data into a six or more axis representation of the motion of the single piece of sports equipment; and communicating the six or more axis representation to a multimedia facility.

### CROSS-REFERENCE TO RELATED APPLICATIONS

This application claims the benefit of the following provisional application that is hereby incorporated by reference in its entirety: Ser. No. 60/951,245 filed Jul. 23, 2007.

### BACKGROUND

1. Field

The methods and systems herein disclosed generally relate to accurate motion tracking and interactive simulation of moving objects. The methods and systems herein disclosed particularly relate to real sports equipment motion detection, tracking, and visualization in an interactive simulation environment.

2. Description of the Related Art

Determining an absolute position of an object has been beyond the capability of a single embedded sensor technology. Therefore to be able to achieve this ‘systems’ of different technology sensors are implemented. Typically these systems rely on external sensors or radio beacons to supply a reference point, and internally a ‘suite’ of sensors to turn acceleration data into speed and direction data, which when combined with the external reference data can be converted to positional data. These internal sensor systems are often referred to as ‘6-axis’ capable, since they must measure motion in the x-y-z axes and the twisting moments of yaw, pitch, and roll. Shortcomings of these systems include high cost, complexity, large amounts of raw data that require high degree of computation, and thus large power supplies that must be scaled accordingly.

Additionally, previous 6-axis capable sensor systems, such as ones utilizing an accelerometer and a gyroscope assume the sensors are co-located to minimize the complexity of the calculation. In practice, since the actual sensor mechanisms cannot occupy the same location and instead are placed as closely as possible, the resulting error is ignored. While ignoring the resulting error appears convenient, the error becomes a dominant factor when high resolution and complex forces and movements are present.

Error accumulation is also a known problem with calculating absolute real-world position based on sensed motion and implied motion based on sensed acceleration. Very slight errors in measurement or calculation result in, very large errors over time. Such ‘dead reckoning’ systems have as a result been largely limited to applications requiring short periods of time, or those that have an external known reference point such as a beacon or other supplemental source of authoritative positional reference such as GPS.

### SUMMARY

A real-ball interactive sports entertainment and training system may combine real-time motion sensing of real world sports equipment with advanced simulation and presentation capabilities to create simulated interactions with amateur or professional sports figures on-screen, while facilitating in-game advertising into each experience. In addition, the user experience may extend to the Internet, where users can view their statistics and highlights and compare notes and simulated sports stories with other Cybersports users, referred to as “cyber-athletes” or “cyberjocks.”

Sensing user actions that cause movements of a sports object used to play a game may be accomplished by embedding one or more motion sensors into the object and interpreting the sensed motion to determine user actions and/or reactions. Sensing user actions in this way may enable users to virtually compete in visual simulations of amateur and professional sporting events and other athletic challenges, all with real sports equipment facilitating the interactivity. Transmitting signals representing the movements of the sports object to a user performance-sensing facility (e.g. a stream processor associated with a game console) may be accomplished by equipping each motion-sensing device with Bluetooth, RF or other similar wireless technology capable of delivering an instantaneous and continuous flow of motion-sensing data to a stream processor.

Sensing and orienting each user action in relation to the visual presentation of the sport situation depicted on-screen may be supported by interpreting the motion-sensing information via the stream processor in the computer or game console and integrating the motion data into the game software for real-time interactivity. The adapted real sports equipment with embedded motion sensing facilities may also include position or orientation sensing to determine an initial position and therefore determine an actual travel path and rotation related motion of the sports equipment.

Presenting a virtual continuation of the actual sensed path of the adapted sports equipment (e.g. baseball, basketball, etc) facilitates delivering an image that seamlessly combines the user and the actual sports equipment with virtual amateur and professional athletes featured within a variety of sports-themed settings on-screen. Determining the success of the user against the on-screen athletes, who react in direct response to the actions of the user, may be combined with any adjustments that are required based on the user's pre-selected skill level.

In an example of a commercial application of the invention, customers interested in competing may be required to pay for their interactive sports experience, which, by way of example only may be $2.00 per play for a 2-minute experience, or $30-$40 for a one-hour experience. These payments could preferrably be made using smart cards in the form of either existing debit or credit cards, such as those offered by Mastercard, Visa, and the like or customized, branded cards issued in association with the invention that may offer special membership benefits to those who play the games regularly. For in-home use, online payment methods, such as PayPal and the like may also be used for in-game micro-transactions. In an objective of the invention, smart card or credit card payment transactions may facilitate extracting various demographic and user identification information by automatically transferring it from each customer's card directly into a database system. Automatic transfer of user data makes the process of associating each user's performance with a user account and then ranking and uploading data related to each user performance to a secure web site as seamless as possible.

Once the user meets any payment obligations and the various demographic data has been automatically registered in the system, the player may be offered choices as to what sport to play, with whom and against whom, on what skill level, the duration of play, and the like. To facilitate this process, the platform may include a touch-screen, remote, and/or a responsive voice recognition system, so that each player can quickly and easily navigate all these selections without the need for a touch-screen menu or other type of peripheral interface.

In another, more detailed example of an interactive user sequence a user approaches an embodiment of the invention and uses a smart card to activate it. The user then utilizes the voice-activation system to make all pre-game selections. The user then collects the appropriate sports equipment needed to play his or her game of choice.

The subsequent game experience will be substantially intuitive, as the user will use real (technologically enhanced but still regulation) sports equipment to execute all the plays. When the game starts, an object-tracking system will sense the user's actions through movements of the adapted sports equipment (e.g. ball, puck, and the like) being used in each play with the embedded motion sensor technology capturing all the necessary motion data for transfer via wireless Bluetooth, RF or similar transmitting technology. This information may be received by a device in a computer or game console, which may translate the motion-sensing information into an orientation of the user in relation to the projection screen. Therefore, using multi-axis motion sensors embedded into actual sports equipment, the tracking system may measure velocity, acceleration, rotational forces, and a wide range of differential axis measures. The console, in collaboration with the game and simulation software, may instantaneously assess and determine user performance, providing an accurate depiction of the sports action from any point in time, such as when the moving sports equipment makes contact with the projection screen, until the play reaches an on-screen conclusion.

A virtual representation of the moving sports equipment will immediately appear on the presentation screen in an authentic continuation of its flight. In an example, the flight may include the object moving away from the user in what seems to be three-dimensional space with on-screen athletes reacting to the flight of the moving object in real time.

Another aspect of the invention may include a method of storing and ranking user performances in a database and uploading these results to a web site, where an online community of “cyberjocks” and their fans and supporters may develop. The method may include providing a plurality of internetworked performance-sensing facilities to provide remote competitions as well as an online community for hosting various real-sport simulated sports activities and contests.

To facilitate broadcasting each user's highlights and statistics, and offering these for personal viewing on the internet, individual user ID's and passwords may be used to establish login credentialing and security. Each user's performance may be ranked with other members of the community through a detailed rating system, such as may be designed to determine best performers by age, gender, and other demographic and performance metrics. Each user may seek feedback from the community based on the user's statistical performances in comparison with the user's peers as well as the user's favorite professional athletes, coaches and sportscasters. In embodiments, a facilitator of the community may help arrange for valid and proper feedback.

Top ranked users' experiences may be broadcast at least to the established community if not in a public forum. The broadcast may be in the form of leader-boards for cumulative statistics and highlights from the “Top Play of the Day” nominees. Automated methods to receive viewer opinions on these publicly broadcasted actions via a process of online voting and, based on a daily tally of these votes, may determine the winners for the “Play of the Day Award” for each age-gender category. The community may formalize its contest format by hosting ad-supported promotional contests in collaboration with advertising sponsors who may offer prize awards, allowing all eligible “cyberjocks” to compete on an ongoing basis in each sport.

The invention may facilitate developing an online community by creating seamless interfaces between a payment system (e.g. smart card/credit card), user identification, touch-screen, voice-activation inputs, a customer database, and each game's scoring system so that the pertinent user information can all be compiled, organized and uploaded to the web site in a way that is timely and reliable.

These types of real-sport to simulated-sport interactions may take place in a plurality of deployments across the country or around the world. As such, the ability to capture each player's performances and store this information, including video highlights, will facilitate hosting world-wide competitions, while at the same time creating a world-wide online community for cyberjocks to gather, compare stats, videos and other sports-related items of interest, and potentially be recognized within if not outside the community for their athletic prowess.

A feature of the site is that the private web pages and public forums will be equipped to show video clips of users' athletic performances from any of the real sports tracking and interactive simulators. Highlights may include a compilation of videos of each player, along with on-screen continuations of each play, shown in full-speed or slow-motion at the discretion of the viewer. Highlights may also feature the option to show a “visual trail” of the flight of the ball or puck to indicate accuracy as well as any curve or bend placed on a shot, pass or pitch. In baseball, for added effect, each batter's strike zone would be delineated and, in relation to this indicated area, pitches thrown by a user would be outlined in the locations where they cross the plate.

By offering “search by name” and personal passwords to online site members, each user will be able to access his or her own personal web page. These pages may be similar to any professional player's online bio, but each user may potentially have a separate page for each of several different sports. A user's page may feature access to video footage showing each user's interaction experiences as well as individual statistics and other personalized items. Amateur athletes will be particularly interested in utilizing this site to track their progress and monitor how much they are improving.

Based on skill level, speed, accuracy and overall success as per the parameters of each game, users will be ranked accordingly within each of at least age-gender categories. These rankings will be accessible on individual private web pages so individuals can see how their performances measure up. For top performers, rankings and performances will also be posted in a public forum, with top scorers in each age-gender category recognized via leader-boards showing top performers' cumulative statistics as well as the daily high scores and top video highlights for that day. Thus, in addition to users having the opportunity to view their own personal statistics and highlights privately, each day top players will be recognized, such as in an “Elite Athlete” section of the Web site, where certain athletes, particularly those with high scores for their age and gender categories that day, as well as those who contributed to the daily highlight reel, will be honored publicly. All visitors to this public forum can get involved by viewing a selection of video highlights and voting for their favorite “Play of the Day” nominees in each category.

With an online scoring system, it will be natural to host competitions. It is an object of this invention that these competitions will attract promotional sponsors interested in offering prizes to the champions from each age-gender division.

In an aspect of the invention, a method includes embedding a plurality of three-axis motion sensors within a single piece of user sports equipment, wherein each of the plurality of sensors provides a continuous stream of relative motion data for each axis; disposing the plurality of three-axis motion sensors so that none of the axes are aligned; connecting the disposed motion sensors to a processor, and powering the sensors and the processor so that the processor receives the relative motion data; converting the relative motion data into a six or more axis representation of the motion of the single piece of sports equipment; and communicating the six or more axis representation to a multimedia facility.

In the method, the plurality of sensors consists of four three-axis motion sensors, and disposing the plurality of axis motion sensors comprises positioning the four sensors at the vertices of a regular tetrahedron. In the method, the plurality of three-axis motion sensors is identical except for commercial manufacturing variations. Disposing the plurality of three-axis motion sensors comprises mounting each of the plurality of three-axis motion sensors to separate printed circuit boards. Alternatively, disposing the plurality of three-axis motion sensors comprises mounting each of the plurality of three-axis sensors to a single flexible circuit and fixturing the flexible circuit to ensure that each axis of each of the plurality of motion sensors is not parallel to and not perpendicular to any of the axes of any other of the plurality of motion sensors.

In the method, receiving the relative motion data comprises sampling each continuous stream of relative motion data at least sixteen times per second. In the method converting the relative motion data into a six or more axis representation of the motion of the single piece of sports equipment includes performing differential axis measurement.

In another aspect of the invention, a method includes providing a networked computing facility with a multimedia interface for receiving, using wireless communication, a consolidated continuous stream of relative motion data from a plurality of three-axis sensors that are embedded in a single piece of user sports equipment, wherein the three-axis sensors are disposed so that none of the axes are aligned; presenting a visualization of the sports equipment in the multimedia interface, wherein the visualized sports equipment follows a determined path based on the consolidated motion data stream; and presenting a visualization of an athlete in the multimedia interface, wherein the athlete visualization is adapted to interact with the visualized single piece of sports equipment, and wherein the interaction is based on a simulation model of the athlete's interaction with real sports equipment.

In the method, the plurality of sensors consists of four three-axis motion sensors, and disposing the plurality of three-axis motion sensors comprises positioning the four sensors at the vertices of a regular tetrahedron. In the method, receiving the relative motion data comprises sampling each continuous stream of relative motion data at least sixteen times per second. Alternatively in the method, converting the relative motion data into a six or more axis representation of the motion of the sports equipment includes performing differential axis measurement.

Further in the method, the visualized interaction between the visualized sports equipment and the visualized athlete is derived using inverse kinematics simulation. Alternatively in the method, the athlete is a professional athlete, and the visualization of the professional athlete is based on an association of the professional athlete simulation model and video images of the professional athlete interacting with real sports equipment.

In the method, the consolidated continuous motion stream consists of at least twelve axes of motion data.

In a related aspect of the invention, the method further includes one or more of: determining a performance ranking associated with the visualized sports equipment based on the athlete's simulated interaction with the visualized sports equipment; communicating the ranking to a web server and recording the ranking in a secure-access participant ranking web page; and determining a subset of the rankings that represents top performers and presenting the subset on a public-access participant ranking web page.

In another aspect of the invention a system includes a plurality of three-axis motion sensors embedded within a single piece of user sports equipment, the three-axis motion sensors for sensing motion of the single piece of user sports equipment and providing a continuous stream of relative motion data; a printed circuit board assembly forming a regular tetrahedron shape, wherein the plurality of three-axis motion sensors are disposed at the vertices of the regular tetrahedron; a processor for sampling the continuous stream of relative motion data from the plurality of three-axis motion sensors and for converting the relative motion data into a twelve or more axis representation of the motion of the piece of user sports equipment; and a multimedia facility for receiving the twelve or more axis representation of the motion and producing a visualization of the motion of the single piece of user sports equipment. In the system, the visualization of the motion of the single piece of user sports equipment is projected based in part on a subset of data provided by the plurality of three-axis motion sensors. Alternatively in the system, the plurality of three-axis motion sensors consists of four substantially identical sensors.

In embodiments, the methods and systems herein may include determining relevant motion from a continuous stream of motion data.

In embodiments, the methods and systems herein may be associated with receiver position-independent sensing of real sports equipment motion.

In embodiments, the methods and systems herein may be associated with wireless interfaces that are customized or adapted to interface with consumer and commercial game consoles.

In embodiments, the methods and systems herein may be associated with virtual reality sports leagues, teams, contracts, fans, venues, virtual currency, and the like.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a schematic view of key elements in an embodiment of the invention.

FIG. 2 depicts an arrangement of some of the elements of the invention forming an interactive real sport simulator.

FIG. 3 depicts an embodiment of a motion sensing facility.

FIG. 4 depicts a flow chart of an operation of the system

FIG. 5 depicts an exploded view of a baseball application.

FIG. 6 depicts key technologies and data flow of the invention.

FIG. 7 depicts key sport equipment to be adapted with an embedded sensor facility.

FIG. 8 depicts key elements of a complete real-sports equipment tracked experience

FIG. 9 depicts a personal user web page.

FIG. 10 depicts a public forum web page.

### DETAILED DESCRIPTION

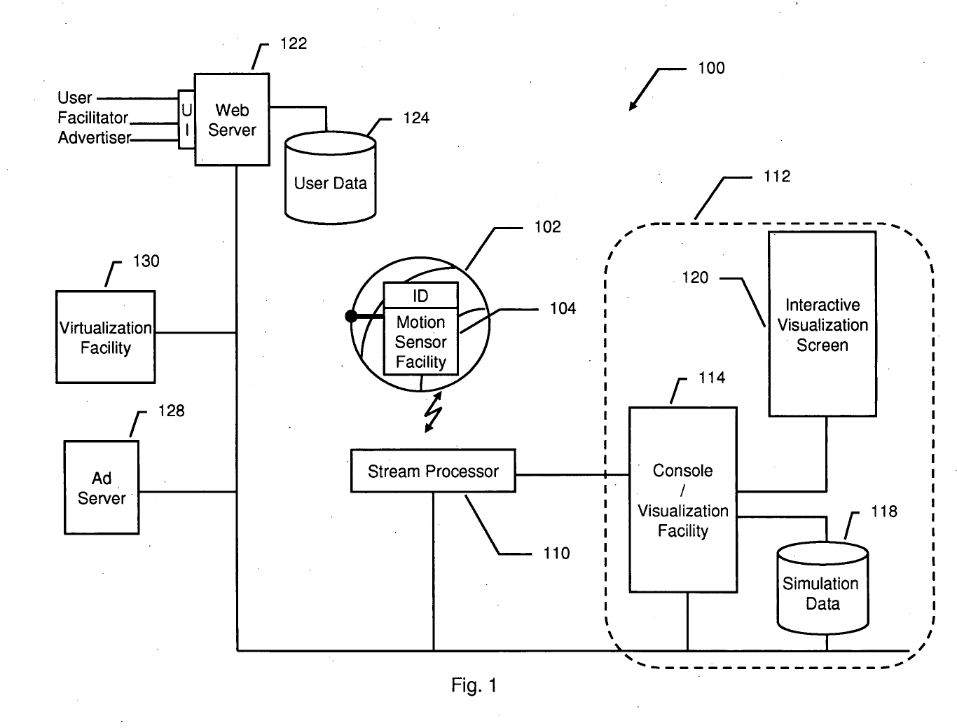

Referring to FIG. 1, tracking and interactive simulation of real sports equipment may be performed by a platform 100. The platform may include real sports equipment 102 adapted to be wirelessly tracked for all forms of movement. The adapted real sports equipment 102 may include a motion detection and transmission facility 104 that may provide a continuous stream of six or more axis position and motion data. The stream of data may be received by a stream processor 110 that may communicate through two way communication with the adapted sports equipment 102. The processor 110 may take the received data from one or more adapted sports equipment 102 and configure it to be readily receivable by a visualization facility 112. The visualization facility may include a console 114 for interacting with the processor 110, a network, simulation data 118, and an interactive visualization screen 120. The visualization facility 112 may include computer processors and software to project real-time simulated images of the adapted sports equipment 102 based on motion information provided from the processor 110. The visualization facility 112 may also use simulation data, such as images, video, backgrounds, real sports 3D surface models, professional athlete models, physics models, inverse kinematics models, and the like to present a 3D image on the visualization screen 120 of the real sports equipment 102 in an environment configured from the simulation data. Users may interact with the visualization facility 112 through physical interface associated with the console 114, a voice activated interface, a smart card near proximity interface, and wirelessly (e.g. through a smart phone, pda, or other wireless enabled device). The visualization facility 112 may be networked to the internet so that an internet user may interact with the facility 112 for configuration, inquiry, setup, data collection, advertising, and the like. Simulation data 118 may be accessible locally by the visualization facility 112 or may be accessed remotely, such as through the internet, an intranet, a local WiFi network, and the like. The platform 100 may include a web server 122 through which users, a platform facilitator, advertisers, and the like may access the processor 110, visualization facility 112, and the like. The web server 122 may have access to local or remote data storage that may be associated with one or more users of the adapted real sports equipment. This user data 124 may be configurable by a user that is authorized to make changes to the user data, such as when a user logs into the web server through the secure user interface. Advertisers may access aspects of the platform 100 through a web server 122 interface. Alternatively, advertisers may operate an advertisement server that may interact with at least the visualization facility 112 to supply advertisements, product placements, logo replacements, and the like to be incorporated into the visualization. A virtualization facility 130 may be incorporated into the platform for the purpose of facilitating virtual adapted real sports leagues, drafts, players, contracts, venues, promotion, ticket sales, and the like. Virtualization may allow a blending of real world sport performance by participants using the adapted real sport equipment position and motion tracking platform 100 with virtual reality environments in which, for example the participants may try-out for a virtual team in a virtual league. Based on the tracked real-world sport performance, participants may be drafted to a virtual team that may have virtual sponsors, and the like.

The adapted real sports equipment 102, which is further described elsewhere herein, may include any movable sports equipment that can be measured via motion detection, including baseballs, softballs, footballs, basketballs, hockey pucks, soccer balls, golf balls, boxing gloves, bowling balls, lacrosse balls, tennis balls, cricket balls, rugby balls, track and field equipment (javelin, pole vault pole, relay baton) and other projectiles or moving objects that are a natural part of any type of sport. A user may utilize other sports equipment, including without limitation hockey sticks, golf clubs, baseball bats, tennis rackets, lacrosse sticks, cricket bats, along with any other equipment that acts as a natural implement for making contact with the object being measured. The other sports equipment, such as that in the above example list, may also be adapted with a motion sensing facility 104.

The adapted sports equipment 102 may include wireless two way communication with the stream processor 110. The two way communication may facilitate configuring the adapted sports equipment 102 such as by resetting the equipment, adjusting a transmitter frequency, establishing a standby or hibernation mode, calibrating the adapted sports equipment 102, and the like. Data from the adapted sports equipment 102 may be a raw stream of data, may follow one or more industry standard protocols such as Bluetooth, RF, and the like. The data may include a unique identification of the adapted spoils equipment 102 that may be associated with a user account. The stream processor 110 may signal the equipment 102 to be activated based on an event, such as a user paying to use the equipment 102.

The adapted sports equipment 102 may include power saving features such as an ‘at rest’ detector that may power down elements of the equipment 102 to conserve power when the equipment is determined to be at rest. The adapted sports equipment 102 may include an initial activation function that reduces power consumption to a bare minimum until the equipment 102 is activated. In an embodiment, the adapted sports equipment 102 may include a user accessible on/off switch that is accessed with a small tool, such as a toothpick. In equipment that includes threads, such as a baseball, the switch may be accessible through a thread hole in the outer shell.

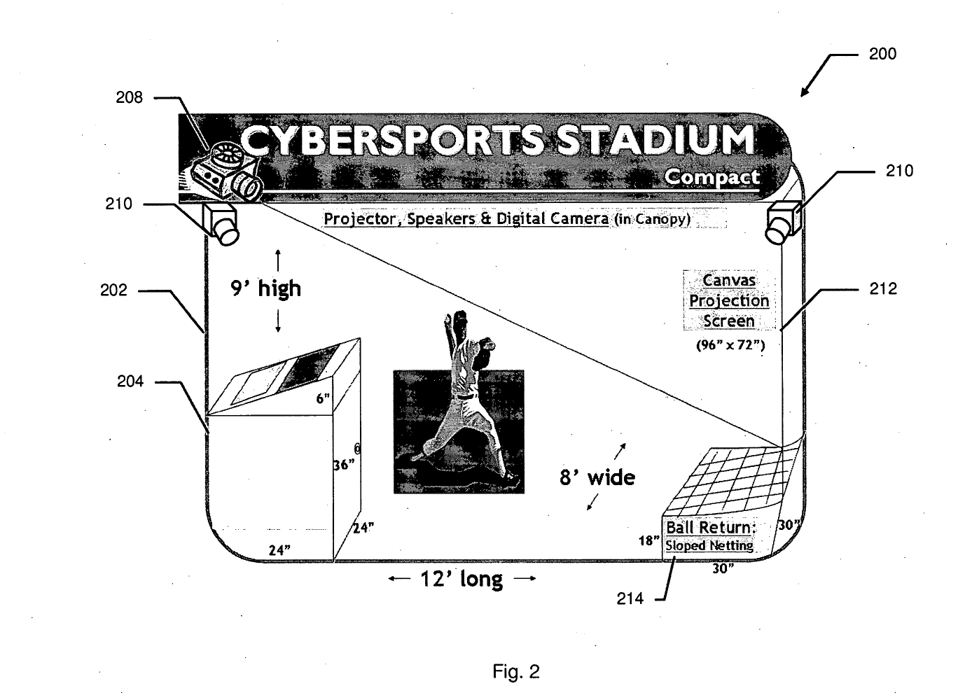

In FIG. 2 an embodiment of a compact configuration of an interactive sports equipment tracking and simulation facility, herein referred to as a ‘stadium’ is depicted. The stadium 200 may include an enclosed structure 202 that is accessible through a door (not shown) or opening in a side of the structure. The stadium 200 may include a console 204, a projector 208, cameras 210, interactive visualization screen 212, ball return 214, and multimedia equipment such as speakers, lights, and the like. The structure 202 may be sized to allow for a variety of sports actions such as pitching a baseball (depicted), batting, kicking a soccer ball, and the like. In the embodiment of FIG. 2, the structure is approximately 9 feet high, 12 feet long and 8 feet wide. The console 204 may include a card reader, proximity sensor, touch screen, processor with internet connectivity, stream processor 110, and the like. The elements of the stadium 200 may be interconnected in a similar way to equivalent elements in FIG. 1. A projector 208 may be positioned so that a visualization of a sports scene, such as a batter, catcher, umpire, and home plate may be presented to the user on the screen 212. The console 204 may communicate with the projector 208 to present a scene consistent with the user's selection of sport, skill level, professional athlete to visualize, and the like. A camera or cameras 210 may be positioned inside each stadium 200 in the upper corners and facing diagonally across the playing area to record action within the stadium 200. Information collected within the stadium 200 by the cameras, 210, console 204, stream processor 110, and the like may be provided over the console 204 internet connections to a web server 122 as depicted in FIG. 1.

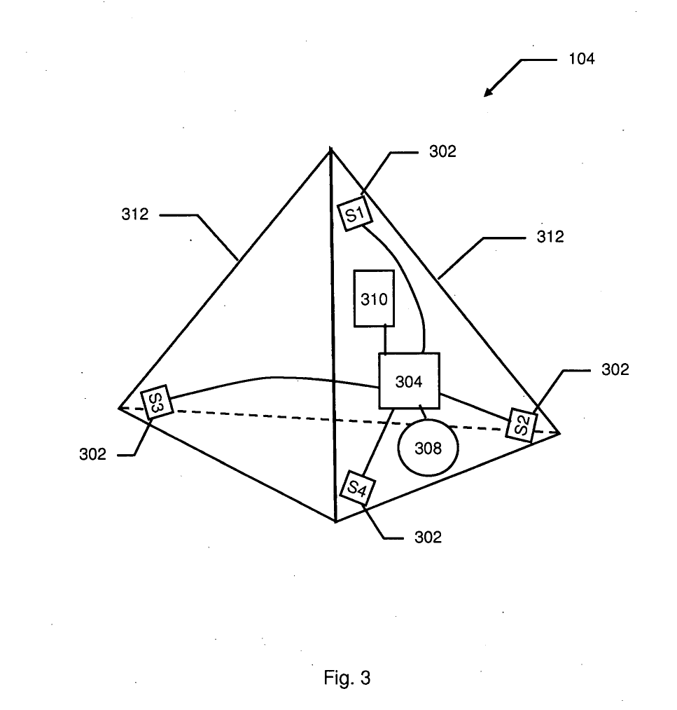

Referring to FIG. 3, real-time sensing may be provided by the motion sensing facility 104 and may include a ‘constellation’ of substantially identical, very low-cost motion sensors arranged in a unique pattern to generate not only the necessary 6-axis data but also additional axes that can be used to increase accuracy while reducing cost, complexity, and size. Since the devices are substantially identical to one another, the data collected from each is similar, which results in simpler processing, which in turn reduces processor complexity, power budget, and other processor support requirements.

The constellation configuration of substantially identical sensors employs a novel approach of separating the sensors in space so that no two axes align. In one embodiment, the sensors would be relatively disposed to ensure that no two axes align but at least one axis of each sensor intersects with at least one axis of at least one other sensor. Alternatively, the sensors could be disposed to ensure that all axes are not aligned and all axes of any one sensor do not intersect with any axes of any of the other sensors. Each of these configurations may provide benefits while presenting assembly tradeoffs that may be evaluated when determining a particular implementation of the methods and systems herein described. In the simplest case of two 3-axis acceleration sensors, software can choose any arbitrary real-world axis, such as a z-axis defined by earth's gravitational force, calculate the acceleration vector for this arbitrary axis from each sensor, and convert the difference between the two sensors' outputs into a real-world 6-axis motion.

This approach provides additional benefits as well. For an object at rest, each sensor would be under fixed 1-gravity acceleration due to the Earth's gravitational field. This information is easily converted to an absolute tilt, or orientation to the Earth's surface.

In addition, a unique benefit to separating the sensors is that they would facilitate sensing the centripetal and/or centrifugal forces of the object as it spins. Centripetal and/or centrifugal force data cannot be collected using any previous combination of gyroscope, accelerometer, and magnetometer. Centripetal and/or centrifugal force data may be particularly valuable for applications of measuring the motion of sports equipment such as balls, pucks, etc. In an example, if the sensors are equidistant from the center of gravity/center of rotation, then centripetal and/or centrifugal force would result in opposite acceleration data for sensors on opposite sides of the center of gravity. The magnitude of acceleration directly relates to rotational speed. The non-alignment may provide that all axis of spin can be detected, because if two sensor axes are aligned and rotation is around the aligned axis, there will be no differential acceleration between the sensors, and spin force associated with the aligned rotation cannot be isolated from linear acceleration. By separating the axes and collecting the acceleration data from all of the non-aligned axes, calculations can be performed on the relative values of acceleration to determine a multitude of rotation related forces acting on the sports equipment.

Since sensing motion based on directional changes in two 3-dimensional coordinate systems that produce x/y/z acceleration and yaw/pitch/roll motion data is referred to as ‘6-axis sensing’, and the methods and systems described herein collect data in at least two additional coordinate systems (e.g. absolute x/y/z orientation and x/y/z rotational velocity), we the methods and systems described herein may be referred to as ‘12 or more axis capable’. Three sensors would provide 3×3×2=18 axis capability, and four sensors would provide 3×4×2=24 axis capability. Tradeoffs of the number of sensors may be made based on accuracy requirements, power budget, size constraints, cost, computing complexity, and the like.

While two sensors with optimal physical placement are theoretically sufficient to collect data on all 12 axes of motion, additional sensors may have the result of significantly reducing quantizing error. With four sensors measuring acceleration in 12 different acceleration vectors, software processing the data may automatically choose an optimum axis measurement for position and motion calculations from the available data streams.

The methods and systems described herein may reduce positional and motion data through a process of modeling known real-world constraints on the individual sensors.

For an object in flight, such as a thrown ball, a typical 6-axis capable sensor system would sense this flight as a lack of any input since no external forces, (other than gravity which is constant and therefore has no measurable input) are acting on the system. The methods and systems herein would similarly sense an object in flight, but the accelerometers will sense the object's deceleration due to air resistance, thus determining a reference point for the object direction of travel. Similarly, lift generated by the object's spin would also be sensed, but since the multiple sensors can accurately measure spin via centripetal and/or centrifugal force, the lift data can be measured distinctly from air resistance along the direction of travel. Additionally, transient environmental conditions, such as cross wind gusts can be measured because the conditions may be characterized as an acceleration that cannot be attributed to line-of-flight resistance and lift associated with spin.

For objects not in flight, those being either at rest or in the process of being thrown, the concept of modeled constraints also applies. The sensor array and thus the object can be known to be at rest and idle when all sensors report one gravity of acceleration from the earth in a consistent direction. Therefore, being able to detect when the object is at rest and when it is in free-fall (in flight) facilitates knowing that the object is in the throwing process. During the complex motions of throwing, much is understood about the real constraints to this motion; a wrist, elbow, and shoulder can make limited motions relative to each other. These physiologic limitations can be used to correct small error measurements and greatly reduce accumulated errors by providing constant feedback. The outcome is not necessarily to greatly increase positional accuracy, but to prevent runaway accumulation of error that would normally result in wildly inaccurate positional data after a few seconds of complex motion.

Although an example of throwing a ball is used in this disclosure, the methods and systems are not limited to this example. The methods and systems described here may be applied to any other type of sport equipment that can be moved, such as a basketball, javelin, hockey puck, and the like.

The motion sensing facility 104 depicted in FIG. 3 may include two or more 3-axis acceleration sensors 302 separated in space as herein described. The sensors may be placed on two printed circuit boards 312 that are disposed to facilitate the sensors forming a regular tetrahedron with a sensor 302 attached at each of the 4 vertices. As a result each sensing axis is a multiple of 60 degrees out of alignment with every other axis. Alternatively, the facility 104 may be composed of one printed circuit board that is creased to form the tetrahedron.

Representative sensors 302 may include accelerometer MMA7260QT by Freescale Semiconductor. A processor 304 suitable for interfacing with the sensors 302 and a communication device may include the Microchip PIC18F24K10 processor. Power may be provided by a battery 308, such as the CRF2450 Lithium coin cell. Wireless communication may be facilitated by a radio device 310 such as Linx TXM-916-ES 916 Mhz transmitter, however higher frequency burst transmitters in the 2.4 GHz or higher range may provide lower power consumption.

Although sensors, such as gyroscopes, accelerometers and compasses have been available in various forms for many years, recent developments in Micromachined Microelectromechanical Systems (MEMS) technology have resulted in a new generation of sensors that are relatively low cost, accurate, fast, and can measure a very wide range of inputs. It is noteworthy that gyroscopes required by traditional 6-axis sensing systems remain roughly ten times as expensive as an accelerometer of the same class. While the trend to smaller and cheaper sensor devices can be expected to continue, the complexity of manufacturing a gyroscope sensor shall remain far greater than that of an accelerometer. The same can be said for solid state compasses, which require complex magnetic field sensors and still suffer from very limited accuracy. The methods and systems herein benefit from eliminating the gyroscope and not depending on a compass for an external reference.

Motion sensing may be particularly effective when the motion data can be read by a subscriber in real-time over a wireless connection, such as a radio or infrared link. Both methods place a high demand on power consumption, imposing limitations on the amount of data that can be sent and thus the amount of sensor data that can be processed and transmitted. The invention is particularly suited to overcome these limitations, since using substantially identical sensors may mean that equivalent sensors' data streams can be integrated to a compact set of data with relatively modest processing.

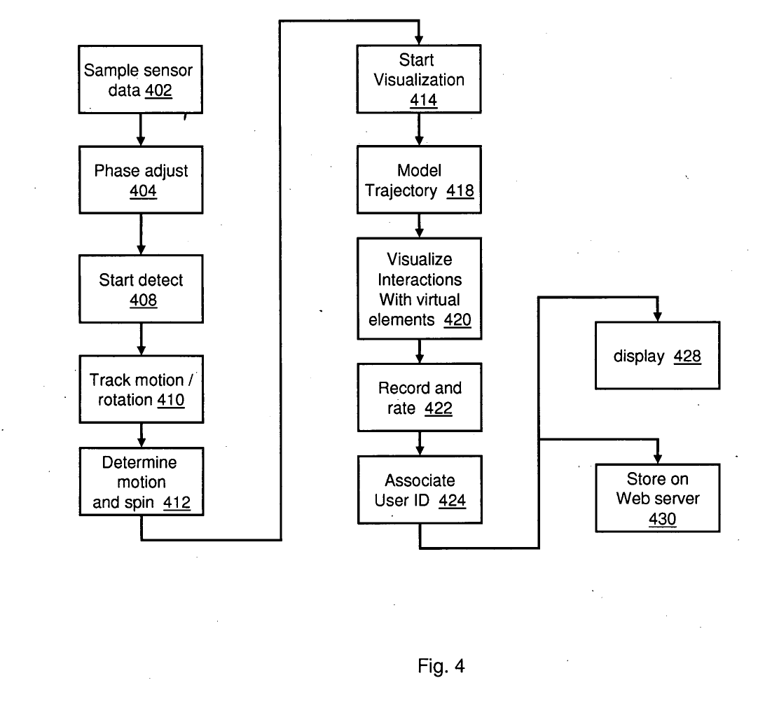

Referring to FIG. 4, a flow chart of potential steps associated with the methods and systems herein described, data from the plurality of sensors may be sampled 402. The sample frequency may be arbitrary, but an exemplary sample frequency facilitates acquiring sixteen samples from each axis of the plurality of sensors each second. The sampled axis sensor data may be processed 404 to adjust for any phase shift associated with the acquisition or transmission of the data from the physical sensors to a processing facility such as a stream processor 110 that is depicted in FIG. 1. The data may be analyzed to detect a relevant start of motion 408 data set. This may be detected by identifying that the object is at rest or that the object has transitioned from one type of motion (e.g. a baseball being manipulated by a pitcher to position the ball for throwing) to another type (e.g. pitcher going into a windup motion). This may alternatively be detected by the adapted sport equipment 102 being detected as in a known position (e.g. a golf ball being placed on a tee).

Once a start of motion sequence is detected in step 408, the motion of the adapted sport equipment 102 may be tracked 410 by collecting motion samples from the sensing facility 104. The tracked data may be analyzed 412 to generate motion related vectors, moments, torque, and other forces and movements as may be determined from the plurality of sensors 302 in the motion sensing facility 104.

Data representing the motion of the object generated in step 412 may be provided to a visualization engine to start visualization 414 of the sport equipment in motion. The visualization engine may use a predetermined physics or inverse kinematics model of the adapted sports equipment 102 to provide a highly accurate visualization that is true to the motion of real sport equipment. A trajectory of the adapted sport equipment 102 is modeled 418 and the object is presented in a visualization following the trajectory.

The visualization may include simulation of objects, people, animals, vehicles, other sports equipment, and the like and the interactions between these simulation elements and the visualized sport equipment following the determined trajectory may be simulated 420 and visualized. Data related to these interactions and the determined trajectory may be collected and analyzed to generate a rating 422 for the sensed and visualized event. The data and ratings may be associated 424 with a user ID and the data may be provided to display process 428 for local display. Additionally the data and ratings associated with the user may be stored 430 in a web server so that the user can access the data through a client interface, such as a web browser.

Simulation of the visualization of the moving sports equipment, virtual participants (e.g. professional athletes), and other visualized aspects disclosed herein, may be modeled and controlled, for example, using equations of motion, such as inverse kinematics (IK) equations that describe the motion of a feature, such as a professional athlete, in a coordinate system. Generally, a set of equations may be established that describe each sub-part of the athlete, based on the athlete's measurements and estimated degrees of freedom, such as the athlete's ability to react to the simulated sports object. IK equations may be used, for example, to predict the impact of a simulated baseball bat with a visualized projection of a pitched baseball.

An external programming environment that may be associated with the methods and systems herein described may include, for example, a .NET object layer for users with Microsoft's .NET software development platform. The .NET framework offers a development environment for Microsoft Windows and web applications, as well as more atomic components and web services. While the .NET framework is one useful programming paradigm for deploying services and various internet and intranet applications, it will be appreciated that other environments may also, or instead, be usefully employed with the systems described herein. For example, a distributed computing environment may be supported by Java EE from Sun or Component Object Model (“COM”), Microsoft's precursor to .NET. Similarly, the simulation models of the professional athletes may be packaged as libraries or subroutines for a standalone application, or may be deployed as a service, such as a web service (such as in a services oriented architecture), or through a web-accessible interface. All such software implementations, as well as variations and combinations thereof, are intended to fall within the scope of this disclosure.

An application programming interface (“API”) that is associated with the methods and system herein described may communicate with other software aspects of the platform 100 using, for example data messages, a TCP packet stream, or any other message-oriented, connection-oriented, serial, or other communications protocol. In one embodiment, the API exchanges data messages with the .NET object layer of the external programming environment. More generally, the API may include any set of definitions of the ways an external computer system communicates with the internal functional modules of the platform 100. Thus, any predefined programmatic interface may be used as the API of the platform 100, provided the API may be suitably adapted to the external programming environment.

In one aspect, the API may accommodate explicit access to each of the facilities of the platform 100, so that a programmer may, for example, configure, refine, load, customize, analyze, or otherwise manipulate the simulation features. In embodiments, a simulation module may take as inputs three-dimensional models from one or more three-dimensional visualization modules, such as commercially available modules.

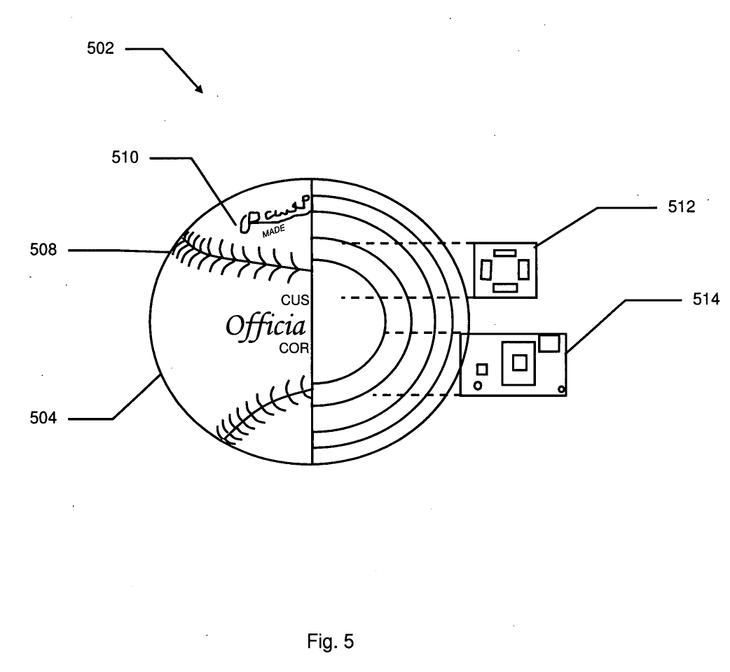

Referring to FIG. 5, a cut away exploded view of a baseball embodiment of the present invention, the exterior appearance of the baseball 502 may provide the look and feel of a real baseball. The adapted baseball 502 may include a cowhide cover 504, may weigh between five and five and one quarter ounces, may include a regulation one-hundred eight stitches 508, the circumference may be between nine and nine and one quarter inches, and the cover 504 may include a brand name, such as a brand name of a real baseball manufacturer 510. Internally, the baseball 502 may be made up of substantially similar materials in a similar construction technique as a baseball with the exception that the motion sensing facility 104 may be enclosed in the baseball 502. As described herein, the sensing facility 104 may include electronics for multi-axis sensing 512, processing and wireless communication electronics 514, and optionally may include an access point to service or configure the motion sensing facility 104. In this way, a traditional baseball may be adapted to include the innovative methods and systems of multi-axis motion sensing herein described.

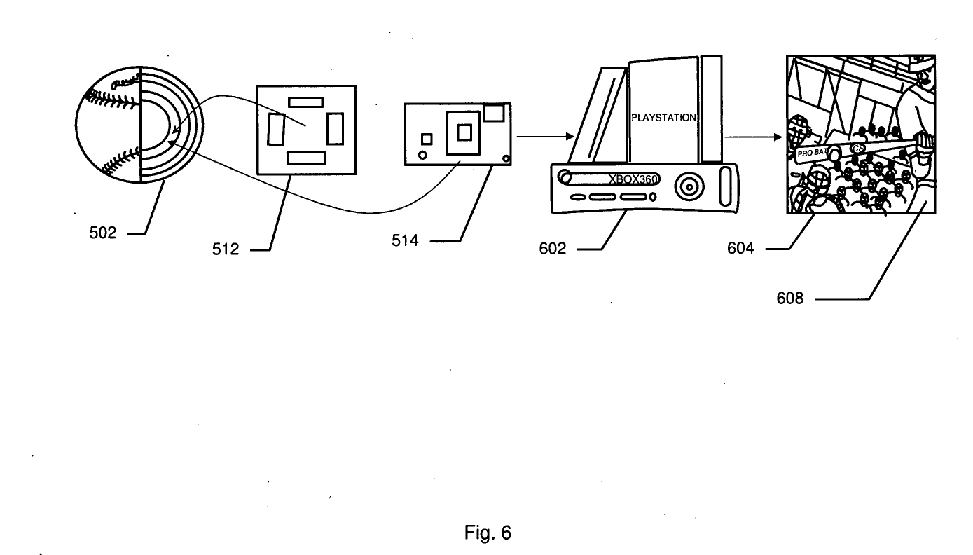

FIG. 6 depicts the adapted real sport equipment of FIG. 5 replacing the common input structures such as a joystick or a wireless remote (e.g. Wiimote). The adapted baseball 502 that includes motions sensors 512 and control/communication electronics 514 interface through a wireless connection with game console receivers 602 that receive and convert the data to 3D rendering data to facilitate integrating the received data with game console display 604. In this way a thrown hall may send sensor data via a Bluetooth or RF link to a receiver of a game console that integrates with the game software to show real-time interaction of the sensed baseball 502 and on-screen participants 608 in real-time.

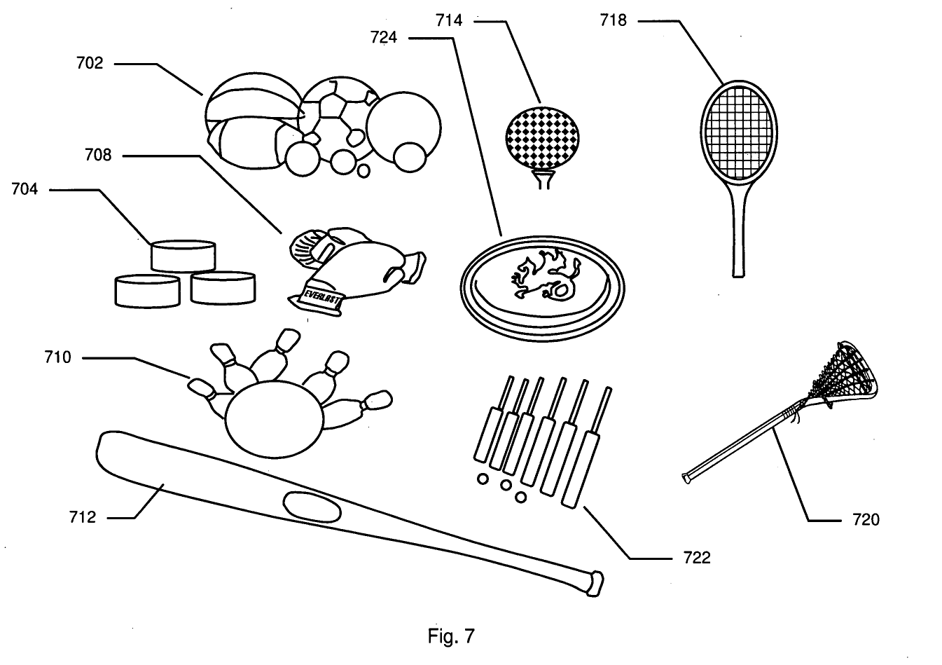

FIG. 7 depicts a variety of real sports equipment that may be adapted with the embedded motion sensing facility 104. FIG. 7 is an exemplary depiction of a subset of the potentially relevant sports equipment and it includes baseball, billiards, softball, volleyball, soccer, basketball, football as represented by element 702. Other exemplary equipment and sports include hockey 704, boxing 708, bowling 710, baseball batting 712, golf 714, tennis racket and ball 718, lacrosse 720, cricket 722, rugby 724, and others depicted here and not depicted here. The methods and system herein facilitate interacting with simulated sports and entertainment activities that go beyond traditional simulated golf or the rudimentary tracking of popular video game controllers. The net result is multiple sports with world-wide appeal.

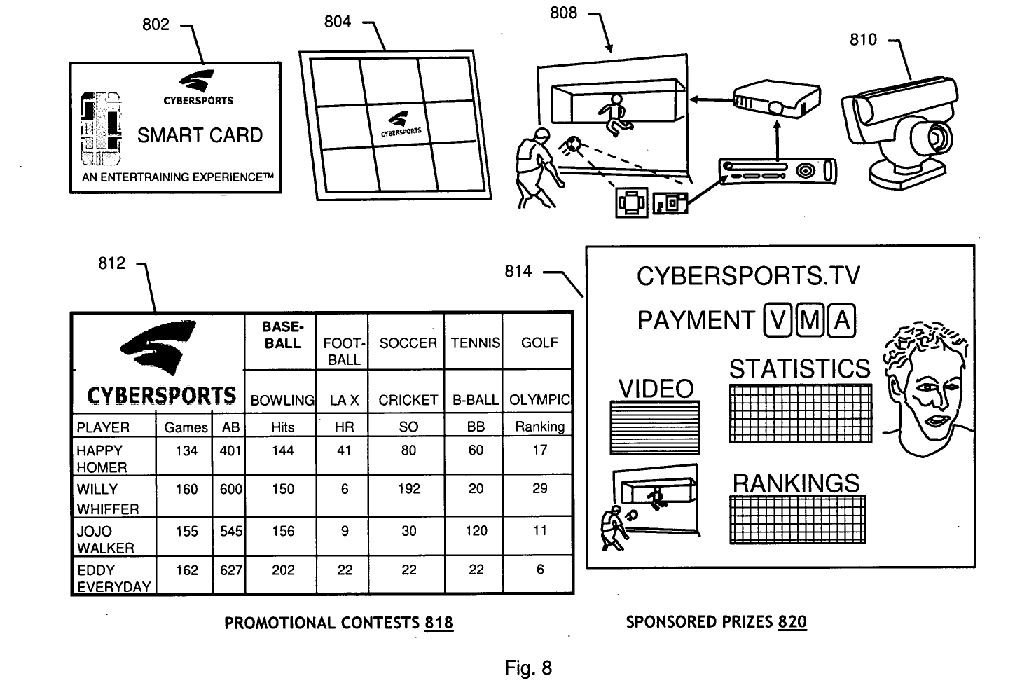

FIG. 8 represents key elements in an embodiment of the methods and systems herein that provide a complete experience for participants. Users of a real-sports equipment tracking and interactive simulation system may gain access to the system through a smart card 802 as herein described. In embodiments, the smart card may be a branded smart card provided through or on behalf of a facilitator of the complete experience system. The participant may also interact with the system through a touchscreen 804 that may be associated with or may represent a user interface of a console as herein described. The participant may select sport, configuration, and recording options, among others using the touch-screen. Participants may get actively immersed 808 in real-sport games. The participant immersion may be captured by digital cameras 810 to record a video of each game. The system may also include a database system 812 that may include player statistics and rankings. The video, statistics, rankings, payment options, and the like may be accessible through a website 814 associated with the system. In embodiments, promotional contests may be offered to participants and participants who participate in the promotional contests 818 may have an opportunity to receive sponsored prizes 820.

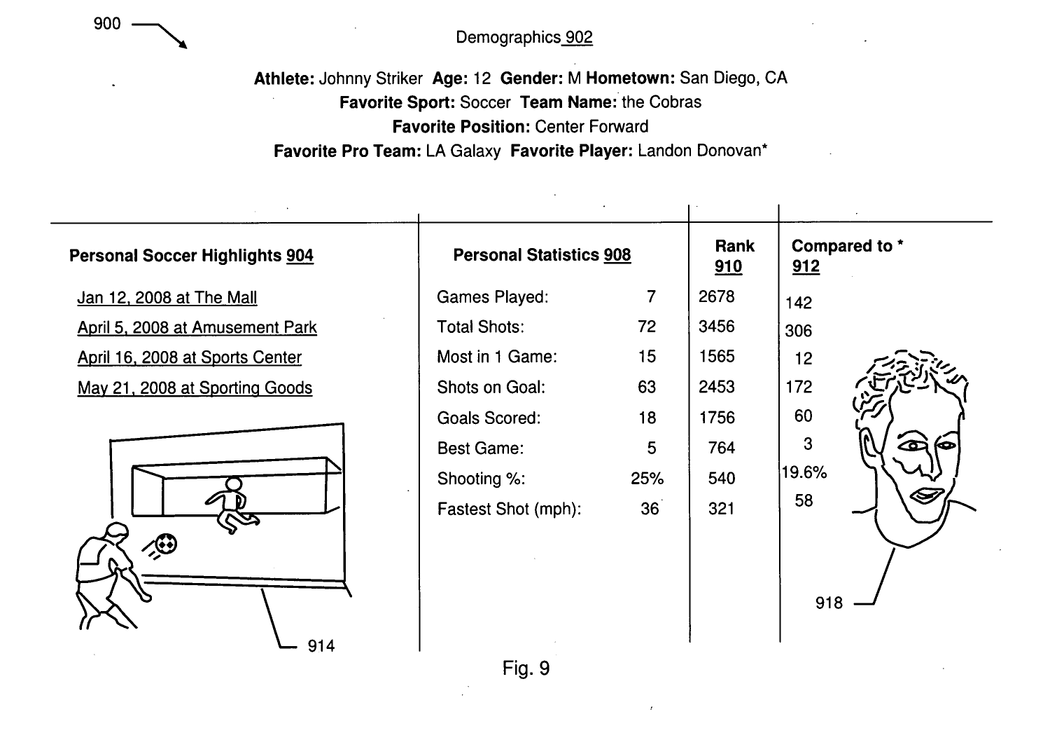

Referring to FIG. 9, an exemplary personal participant web page 900 of the invention, the user may configure demographic information 902. Personal highlight videos 904 of interactive simulation games may be accessible through hyperlinks and displayed in a video window 914. Personal statistics 908 of the participant may be listed along with rank 910, and comparative data 912. Optionally a user may include an image, such as a photograph of the user 918 to be displayed on the personal participant web page 900.

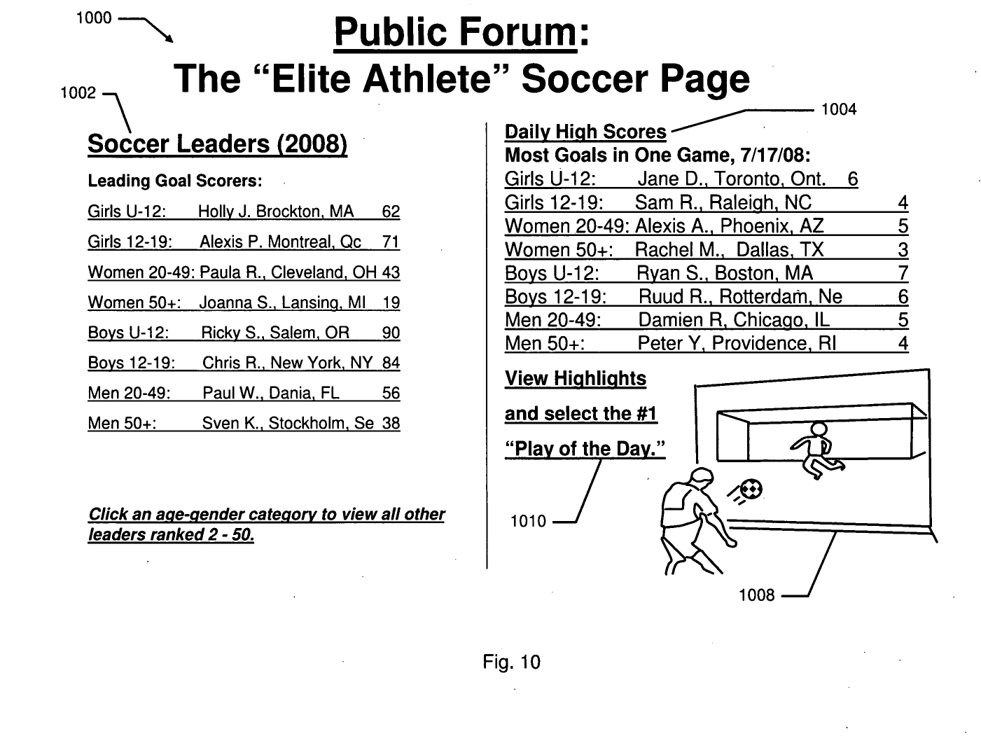

FIG. 10 depicts a public forum web page 1000 of the invention. A public forum page 1000 may be configured for each sport, such as soccer as depicted in FIG. 10. The public forum page 1000 may include a list of leaders 1002 in various age-gender categories. The list may be changed to show a specific category by selecting a category. Daily high scores 1004 may be displayed and updated throughout the day as scores and rankings for each participant use of the system is automatically uploaded to the web server responsible for the public forum page 1000. Additionally, a viewer of the public forum web page 1000 may view highlights 1008 and may vote for the play of the day 1010.

The methods and systems for real sport equipment motion detection and interactive simulation may have applications in a wide variety of sports and sports entertainment as well as many other fields. Below are exemplary descriptions of the utility, benefit, advantages, and applications of the methods and systems herein for some sports related markets. The following descriptions are for pedagogical purposes and not meant to be limiting.

Baseball

As an interface for real-ball simulation games programmed to show virtual baseballs that continue the flight of pitched or batted baseballs, or close facsimiles, and interact with videogame images in real time;

As an interface for skills training activities, separate or combined with the Cybersports (“CS”) baseball simulation games, in which the following data is captured:

Speed read-outs of thrown or batted balls linked to a computer, digital display and any other similar electronic device;

Accuracy analysis of pitches and throws, graphically recreated and depicted in relation to targets, in particular a virtual catcher's mitt, strike zone, cut-off man, first baseman's mitt or advertisers' logos and the like, typically shown on a virtual baseball field as well as other settings;

Distance analysis of thrown or batted balls, graphically depicted in the context of various reference points on a virtual baseball field and other settings;

Player form and technique analysis that is derived from:

Tracking the arm motion and hand path of a pitcher or fielder (i.e. the ball's path prior to its release point) and graphically recreating and depicting that motion on-screen;

For each pitch or throw, a player's arm motion and hand path may be compared to the arm motion and hand path of select professional players as an ideal frame of reference;

Tracking the flight of thrown balls, particularly their acceleration, rotation and the like, and graphically recreating and depicting this acceleration and rotational movement in correlation with the trajectory of the pitch or throw on-screen;

For each pitch, making spin and trajectory calculations and graphically manifesting those calculations on-screen;

The calculations of a pitcher's spin and trajectory for various pitches (fastball, changeup, curveball, slider, split-finger, cut fastball, sinker and the like) may be compared alongside spin and trajectory calculations of pitches thrown by select professional pitchers as an ideal frame of reference;

Tracking the path of a swung bat by embedding multi-axis sensors in two places, the bat: handle and barrel, then translating the data relative to virtual or real pitches and graphically recreating and depicting each swing path on-screen;

For each swing, a player's swing path may be compared to the swing path of select professional players as an ideal frame of reference; and,

in the context of utilizing CS' baseball simulations for purposes of marketing, advertising and promoting third-party products and services, the CS object-tracking system may be applied:

As a means to facilitate experiential marketing interactions between brands and players' interactive experiences by seamlessly placing branding elements into CS' real-ball baseball simulation games and skills training activities, such as having advertisers' logos appear as targets in front of virtual baseball gloves and mitts, in branded “Hit it Here!” animations beyond the outfield wall and as part of any other types of branding images in various virtual locations, and awarding promotional prizes whenever players successfully hit the targets, in addition to many other promotional marketing strategies that may be implemented using this experiential sports simulation platform; and

In the context of online gaming,

As part of a real-ball, virtual fantasy baseball league in which players actually compete via online gaming experiences, all tied together by an avatar-based community that offers social networking features, such as a minor league system, player showcases, contests and tournaments, player drafts, personalized baseball cards, contracts, salaries, stadium and team owners, general managers, team managers, pitching and batting coaches, individual and team statistics, video highlights, “Cybersports Center” broadcasts, trophies, championship rings, awards ceremonies, All-Star teams and the like; and

As part of live promotional events and the like, during which real professional athletes and celebrities appear live via CS' online gaming portal to compete against various players, or “Cyber-athletes”, simultaneously as hitters competing in Home Run Derby contests, as pitchers throwing to Cyber-athlete hitters or as pitchers and field players competing in accuracy and distance throwing contests and the like.

Uses and Benefits Derived from CS' Baseball Applications:

CS' real-ball object-tracking interface may make the baseball game-play completely realistic due to its ability to generate motion data from inside actual baseballs, or close facsimiles, and process all 6 degrees of freedom in real time;

Speed, accuracy and distance feedback with graphical representations for throwing, pitching and hitting may provide players with a clear and quantifiable picture of their performances;

Arm & hand path feedback may allow players to see their pitching/throwing form and technique in a graphical way and recognize nuances in their throwing motion compared to professional standards;

Ball path and rotation feedback may allow players to see their pitching/throwing performances in an in-depth, three-dimensional way and compare them against professional standards;

Combined with arm and hand path feedback, players may be shown the cause and effect between pitching/throwing technique and performance, including how finger placement and pressure on the ball, arm and wrist angle and other mechanics affect the outcome of the throw or pitch;

Bat path feedback may allow players to see their hitting form and technique in a graphical way and compare it to professional standards;

Combined with speed, direction and distance feedback on the player's hits, the player may be shown the cause and effect between hitting technique and performance, including how timing and rotation of the wrists, direction and angle of the bat head through point of contact and other factors collectively affect the outcome of the swing; and,

In the context of CS' baseball simulations being utilized for experiential marketing,

Out-of-home advertising and promotional opportunities that are fully integrated, customizable, experiential and interactive may assist sports marketers in reaching their target audiences in venue-specific ways (e.g., beer ads in sports bars and sports equipment and apparel ads in sporting goods stores).

Similar Motion-Based Technologies Used for Baseball Simulations

Nintendo Wii—uses a mounted optical sensor and an embedded 3-axis motion sensor in its handheld remote control, called a Wiimote (with an optional Wii Motion Plus extension for measuring rotation), which players move around for both pitching and hitting in order to interact with videogame images on-screen;

Visual Sports Systems (“VSS”)—uses a pair of line-scan cameras that track the trajectory and speed of moving pitches and then shows video images of amateur batters' reactions in real time;

Power Alley's Power Pitcher—uses a radar gun and slitted screen to detect speed and pitch location and then shows slightly-delayed video images of Major League batters' responses;

RevFire—uses sensors and magnetic radiation to determine speed and rotation of pitches, which register on a digital display;

3D4Life—uses an accelerometer in a disc, called a “Speed Ring”, that goes around the barrel of a bat to measure and display bat speed; and

Rawlings' Speed Ball—uses an accelerometer and digital display inside a baseball to measure and display a player's throwing speed.

How CS' Tracking System Adds Unique Value Compared to its Competitors

Realism of CS' Baseball Game Simulations

Unlike Nintendo's Wii, CS' Smart Baseballs & Bats may allow players to pitch and make infield and outfield throws using regulation-size base-balls and swing using regulation-size bats within first-person, life-size baseball stadium environments;

CS' multi-axis sensors (6 axes or more) embedded into real baseballs, or close facsimiles, may make the interface and game-play completely realistic, much more so than the interaction offered by Nintendo's Wiimote, VSS' cameras or Power Alley's interactive video screen;

Training Benefits of CS' Baseball Simulations Compared to its Competitors

Nintendo Wii does not use real sports equipment, so it is incapable of providing useful training feedback based on actual athletic performance;

VSS and Power Alley's Power Pitcher only measure speed and direction, so they miss out on the rotation of the ball as well as the more nuanced analysis of a pitcher's arm, hand and finger motions;

CS' performance data and in-depth analysis provides much more comprehensive feedback than RevFire and 3D4Life, which only offer digital read-outs rather than full video simulations;

RevFire measures speed and rotation, but doesn't provide overall analysis of the trajectory and accuracy of pitches and throws;

3D4Life measures bat speed, but does not take into account bat angle, wrist rotation and other factors associated with successful hitting technique and batting results; and

Advertising Benefits of CS' Baseball Simulations

None of the other real-ball baseball simulation systems feature any type of in-game advertising opportunities, much less interactive promotional tie-ins and targeted, venue-specific advertising strategies.

Markets for Cybersports' Baseball Simulations

Entertainment Market—sports bars, entertainment: centers, museums, halls of frame, stadiums, cruise ships, casinos, resorts, movie theaters, military bases, retail stores, malls, retirement communities, fan-fests, college campuses, trade shows, corporate events, promotional events, luxury condominiums, the in-home market and any other place where people may choose to be entertained by playing real-bat, real-ball virtual baseball; and

Fitness & Training Market—athletic training facilities, fitness centers, sports camps, hospitals, schools, colleges, pro teams, sporting goods stores, luxury condominiums, the in-home market and any other place where people may choose to exercise, compete and seek to improve their baseball skills.

Soccer

As an interface for real-ball soccer simulation games programmed to show virtual soccer balls that continue the flight: of kicked, kneed or headed soccer balls, or close facsimiles, and interact with videogame images in real time;

As an interface for skills training activities, separate or combined with the CS soccer simulation games, in which the following data is captured:

Speed read-outs of kicked balls, linked to a computer, digital display and any other similar electronic device;

Accuracy analysis of passes and shots, graphically recreated and depicted in relation to targets, in particular virtual teammates in motion, a virtual soccer net or advertisers' logos and the like, typically shown on a virtual soccer field as well as other settings;

Distance analysis of kicked balls, graphically recreated and depicted in the context of various reference points on a virtual soccer field and other settings;

Player form and technique analysis that is derived from:

Tracking the flight of kicked balls, particularly their acceleration, rotation and the like, specifically in the context of trying to bend them around a wall of defenders and the like, and graphically recreating and depicting this acceleration and rotational movement in correlation with the trajectory of the kick on-screen;

For each pass or shot, making spin and trajectory calculations and graphically manifesting those calculations on-screen;

The calculations of a player's spin and trajectory may be compared alongside spin and trajectory calculations of bended shots by select professional players as an ideal frame of reference;

Showing defensive and goalie reactions to a player's ball-handling with the on-screen image set in motion as if the player is advancing on the opposing team's goal; and,

In the context of utilizing CS' soccer simulations for purposes of marketing, advertising and promoting third-party products and services, the CS object-tracking system may be applied:

As a means to facilitate experiential marketing interactions between brands and players' interactive experiences by seamlessly placing branding elements into CS' real-ball soccer simulation games and skills training activities, such as having advertisers' logos appear as targets in front of the four corners of a virtual soccer goal and as part of any other types of branding images in various virtual locations, and awarding promotional prizes whenever players success-fully hit the targets, in addition to many other promotional marketing strategies that may be implemented using this experiential sports simulation platform; and

In the context of online gaming,

As part of a real-ball, virtual fantasy soccer league in which players actually compete via online gaming experiences, all tied together by an avatar-based community that offers social networking features, such as player showcases, contests and tournaments, player drafts, personalized soccer cards, contracts, salaries, stadium and team owners, general managers, team managers, coaches, individual and team statistics, video highlights, “Cybersports Center” broadcasts, trophies, championship rings, awards ceremonies, All-Star teams and the like; and

As part of live promotional events and the like, during which real professional athletes and celebrities appear live via CS' online gaming portal to compete against various players, or “Cyber-athletes”, simultaneously as shooters competing in goal-scoring contests or passers competing in accuracy and distance kicking contests and the like.

Uses and Benefits Derived from CS' Soccer Applications

CS' real-ball object-tracking interface may make the soccer game-play completely realistic due to its ability to generate motion data from inside actual soccer balls, or close facsimiles, and process all 6 degrees of freedom in real time;

Speed, accuracy and distance feedback with graphical representations for shooting and passing may provide players with a clear and quantifiable picture of their performances;

Ball path and rotation feedback may allow players to see their shooting and passing performances in an in-depth, three-dimensional way and compare them against professional standards; and,

In the context of utilizing CS' soccer simulations for experiential marketing,

Out-of-home advertising and promotional opportunities that are integrated, customizable, interactive and experiential may assist sports marketers in reaching their target audiences in venue-specific ways (e.g., sports drink ads in fitness centers and videogame ads in malls).

Similar Motion-Based Technologies Used in Soccer Simulations

Visual Sports Systems (VSS)—uses a pair of line-scan cameras that track the trajectory and speed of moving shots and then show an amateur goalie's reactions in real time; a smaller version uses one set of line-scan cameras with results shown on a mounted video console.

How CS' Tracking System Adds Unique Value Compared to its Competitors

Realism of CS' Soccer Game Simulations

CS' multi-axis sensors (6 axes or more) embedded into real soccer balls, or close facsimiles, may make the interface between object-tracking and game-play completely realistic, much more so than the interaction offered by VSS' camera technology;

Training Benefits of CS' Soccer Simulations Compared to its Competitor

CS' rotational data and in-depth analysis of each facet of a player's passes and shots may provide more comprehensive feedback on player performance than VSS, which only measures ball speed and direction; and

Advertising Benefits of CS' Soccer Simulations

No other real-ball soccer simulation system features any type of in-game advertising opportunities, much less interactive promotional tie-ins and venue-specific targeted advertising strategies.

Markets for Cybersports' Soccer Simulations

Entertainment Market—sports bars, entertainment centers, museums, halls of fame, stadiums, arenas, cruise ships, casinos, resorts, movie theaters, malls, retail stores, military bases, retirement communities, college campuses, fan-fests, trade shows, corporate events, promotional events, luxury condominiums, the in-home market and any other place where people may choose to be entertained by playing real-ball virtual soccer; and

Fitness & Training Market—athletic training facilities, fitness centers, sports camps, hospitals, schools, colleges, pro teams, sporting goods stores, luxury condominiums, the in-home market and any other place where people may choose to exercise, compete and seek to improve their soccer skills.

Golf

As an interface for real-ball golf simulation games programmed to show virtual golf balls that continue the flight of impacted golf balls, or close facsimiles, and interact with videogame images in real time;

As an interface for skills training activities, separate or combined with the CS golf simulation games, in which the following data is captured:

Speed read-outs of impacted balls linked to a computer, digital display and any other similar electronic device,

Accuracy analysis of shots, graphically recreated and depicted in relation to targets, in particular greens, flags, holes, advertiser's logos and the like, typically shown on a virtual golf course as well as other settings,

Distance analysis of impacted golf balls, or close facsimiles, graphically recreated and depicted in the context of various reference points on a virtual golf course, driving range, pitch & putt, putting green and the like;

Player form and technique analysis that is derived from:

Tracking the flight of impacted balls, particularly their acceleration, rotation and the like, specifically to measure hook, slice, backspin and the like, and graphically recreating and depicting this acceleration and rotational movement in correlation with the trajectory of the shot on-screen;

For each shot, making spin and trajectory calculations and graphically manifesting those calculations on-screen;

The calculations of a player's spin and trajectory for various shots (straight drives, dog-legs left and right, iron shots with forward and back-spin, trap shots and the like) may be compared alongside spin and trajectory calculations of shots by select professional players as an ideal frame of reference;

Demonstrating possible causes of the ball's trajectory based on extrapolating the player's club-face angle upon impact as well as an estimation of the player's swing path, or, for greater precision, tracking the actual path of a swung golf club by embedding multi-axis sensors in two places, the handle and club-head, then translating the data and graphically recreating and depicting each swing path on-screen;

Comparisons may be made by graphically depicting the player's club-face angle and proposed or actual swing path alongside club-face angles and swing paths of professional players' shots as an ideal frame of reference; and,

In the context of utilizing CS' golf simulations for purposes of marketing, advertising and promoting third-party products and services, the CS object-tracking system may be applied:

As a means to facilitate experiential marketing interactions between brands and players' interactive experiences by seamlessly placing branding elements into CS' real-ball golf simulation games and skills training activities, such as integrating advertisers' logos into various situations (e.g., to indicate where the 250-foot marker is on a virtual driving range, to highlight the cup at the end of a 25-foot putt, or to show the most desirable area to aim for on a par-3 green as players tee off, and as part of any other types of branding images in various other virtual locations, and awarding promotional prizes when-ever players successfully hit it past, into or onto these targets, in addition to many other promotional marketing strategies that may be implemented using this experiential sports simulation platform; and

In the context of online gaming,

As part of a real-ball, virtual fantasy golf league in which players actually compete via online gaming experiences, all tied together by an avatar-based community that offers social networking features, such as player showcases, contests and tournaments, purses, caddies, individual statistics, video highlights, “Cybersports Center” broadcasts, trophies, awards ceremonies and the like; and

As part of live promotional events and the like, during which real professional golfers and celebrities appear live via CS' online gaming portal to compete against various golfers, or “Cyber-athletes”, simultaneously in various types of contests including stroke play, closest-to-the-pin, farthest drive and the like.

Uses and Benefits Derived from CS' Golf Applications

CS' real-ball object-tracking interface may make the golf game-play completely realistic due to its ability to generate motion data from inside actual golf balls, or close facsimiles, and process all 6 degrees of freedom in real time;

Speed, accuracy and distance feedback with graphical representations of a variety of shots may provide players with a clear and quantifiable picture of their performances;

Ball path and rotation feedback may allow players to see their shooting performances in an in-depth, three-dimensional way and then compare them against professional standards;

Club path feedback may allow players to see their golf swing form and technique in a graphical way and compare it to professional standards;

Combined with speed, direction and distance feedback on the player's shots, the player may be shown the cause and effect between swinging technique and performance, including how timing and rotation of the wrists, direction and angle of the club face through point of contact and other factors collectively affect the outcome of the swing; and,

In the context of CS' golf simulations being utilized for experiential marketing,

Out-of-home advertising and promotional opportunities that are fully integrated, customizable, experiential and interactive may assist sports marketers in reaching their target audiences in venue-specific ways (e.g., cable/phone service ads in luxury condominiums and foot-wear and apparel ads in golf retail stores).

Similar Motion-Based Technologies Used in Golf Simulations

Nintendo Wii—uses a mounted optical sensor and an embedded 3-axis motion sensor in its handheld remote control, called a Wiimote (with an optional Wii Motion Plus extension for measuring rotation), which players swing in order to interact with videogame images on-screen;

Visual Sports Systems (VSS)—uses a pair of line-scan cameras that track the speed and trajectory of golf shots and show the result of each shot in real time;

Full Swing Golf—uses a pair of infrared sensor arrays that track the speed and trajectory of golf shots and show the result of each shot in real time;

About Golf—uses a device placed behind the projection screen that gives off microwave emissions which track the speed and trajectory of golf shots and show the result of each shot in real time; and

DeadSolid Golf—uses a hitting mat with three parallel sensor strips that detect the speed and angle of the club-head through impact with the ball, which, by extension, tracks speed and trajectory of each golf shot and shows the result of the shot in real time.

How CS' Tracking System Adds Unique Value Compared to its Competitors

Realism of CS' Golf Simulations

Unlike Nintendo's Wii, CS' Smart Golf Balls may allow players to hit regulation-size balls and swing regulation-size clubs within first-person, life-size golf course environments;

CS' multi-axis sensors (6 axes or more) embedded into golf balls, or close facsimiles, may make the interface between the object-tracking and game-play completely realistic, much more so than the interaction offered by Nintendo's Wiimote, VSS' cameras, Full Swing Golf and DeadSolid Golf's infrared sensors, and About, Golf's microwave-emitting pad;

Training Benefits of CS' Golf Simulations Compared to its Competitors

Nintendo Wii does not use real sports equipment, so it is incapable of providing useful training feedback based on actual athletic performance;

CS' rotational data and in-depth analysis of each facet of a player's shots may provide more comprehensive feedback on player performance than its competitors' products, which typically only measure the speed and linear direction of the ball; and

Advertising Benefits of CS' Golf Simulations

None of the other real-ball golf simulation systems feature any type of in-game advertising opportunities, much less interactive promotional tie-ins and venue-specific targeted advertising strategies.

Markets for Cybersports' Golf Simulations

Entertainment Market—sports bars, entertainment centers, museums, halls of fame, stadiums, arenas, cruise ships, casinos, resorts, movie theaters, malls, retail stores, military bases, retirement communities, college campuses, fan-fests, trade shows, corporate events, promotional events, luxury condominiums, the in-home market and any other place where people may choose to be entertained by playing real-ball virtual golf; and

Fitness & Training Market—athletic training facilities, fitness centers, golf courses, golf academies, hospitals, schools, colleges, sporting goods stores, luxury condominiums, the in-home market and any other place where people may elect to exercise, compete and seek to improve their golf skills.

Boxing

As an interface for real-glove simulation boxing games programmed to show virtual boxing gloves that continue the movements of real boxing gloves, or close facsimiles, and interact with videogame images in real time;

As an interface for skills training activities, separate or combined with the CS boxing simulation games, in which the following data is captured:

Speed read-outs of punches thrown, linked to a computer, digital display and any other similar electronic device;

Accuracy analysis of punches, graphically recreated and depicted in relation to targets, in particular a virtual trainer's practice gloves, a punching bag, advertisers' logos, sparring partners or competitive boxers in motion and the like;

Punch combination analysis, graphically recreated and depicted to show speed of delivery and accuracy of multiple punches thrown in quick succession;

Player form and technique analysis that is derived from:

Tracking the flight of a punch or series of punches, particularly the acceleration and rotation of a boxer's jab, cross, hook and uppercut, and graphically recreating and depicting the paths of each type of punch on-screen;

Calculating the direction and force of these punches, and graphically manifesting these calculations on-screen;

Comparisons may be made by graphically depicting the boxer's punch trajectories compared with select professional boxers' punches as an ideal frame of reference, and

In the context of utilizing CS' boxing simulations for purposes of marketing, advertising and promoting third-party products and services, the CS object-tracking system may be applied:

As a means to facilitate experiential marketing interactions between brands and players' interactive experiences by seamlessly placing branding elements into CS' real-glove boxing simulation games and skills training activities, such as integrating advertisers' logos into various situations (e.g., practicing with moving logos as targets, having logos as virtual boxers' tattoos which light up when the player punches them, and the like), and as part of any other types of branding images in various other virtual locations, and awarding promotional prizes whenever players successfully hit the targets, in addition to many other promotional marketing strategies that may be implemented using this experiential sports simulation platform; and

In the context of online gaming,

As part of a real-ball, virtual fantasy boxing league in which players actually compete via online gaming experiences, all tied together by an avatar-based community that offers social networking features, such as contests and tournaments, team matches, contracts, salaries, managers, coaches, individual statistics, video highlights, “Cybersports Center” broadcasts, trophies, championship belts, awards ceremonies, titles by weight class and the like; and

As part of live promotional events and the like, during which real professional boxers and celebrities appear live via CS' online gaming portal to compete against various players, or “Cyber-athletes”, simultaneously, in various contests including accuracy of combinations, speed punching, power punching and the like.

Uses and Benefits Derived from CS' Boxing Applications:

CS' real-ball object-tracking interface may make the boxing game-play completely realistic due to its ability to generate motion data from inside actual boxing gloves, or close facsimiles, and process all 6 degrees of freedom in real time;

Speed, accuracy and power feedback with graphical representations of each may provide players with a clear and quantifiable picture of their performances;

Arm & hand path feedback may allow players to see their punching form and technique in a graphical way and recognize nuances in their punching motion compared to professional standards; and,

In the context of CS' boxing simulations being utilized for experiential marketing,

Out-of-home advertising and promotional opportunities that are fully integrated, customizable, experiential and interactive may assist sports marketers in reaching their target audiences in venue-specific ways (e.g., beer ads in sports bars and sports equipment and apparel ads in sporting goods stores).

Similar Motion-Based Technologies Used in Boxing Simulations

Konami's MoCap Boxing—uses an overhead infrared sensor array that recognizes the timing and linear direction of a player's punch in relation to an on-screen opponent that reacts in real time;

Nintendo Wii—uses a mounted optical sensor and an embedded 3-axis motion sensor in its handheld remote control, called a Wiimote (with an optional Wii Motion Plus extension for measuring rotation), which players move around to throw punches in order to interact with video-game images on-screen;

How CS' Tracking System Adds Unique Value Compared to its Competitors

Realism of CS' Boxing Simulations

Unlike Konami's MoCap Boxing and Nintendo's Wii, CS' Smart Gloves may allow boxers to use regulation-size boxing gloves within first-person, life-size boxing ring environments;

CS' multi-axis sensors (6 axes or more) embedded into boxing gloves, or close facsimiles, may make the interface between the object-tracking and game-play completely realistic, much more so than the interaction offered by Konami's single infrared sensor array and rubber grips and Nintendo's Wiimote;

Training Benefits of CS' Boxing Simulations

CS' performance data and in-depth analysis of each facet of a player's various punches may provide more comprehensive feedback on player performance than its competitors' products, which typically only register the linear direction of a punch in the context of a videogame; and

Advertising Benefits of CS' Boxing Simulations

No other real-glove boxing simulation system features any type of in-game advertising opportunities, much less interactive promotional tie-ins and venue-specific targeted advertising strategies.

Markets for Cybersports' Boxing Simulations

Entertainment Market—sports bars, entertainment centers, museums, halls of fame, stadiums, arenas, cruise ships, casinos, resorts, movie theaters, malls, retail stores, military bases, retirement communities, college campuses, fan-fests, trade shows, corporate events, promotional events, luxury condominiums, the in-home market and any other place where people may choose to be entertained by participating in real-glove, virtual boxing; and

Fitness & Training Market—athletic training facilities, fitness centers, hospitals, schools, colleges, sporting goods stores, luxury condominiums, the in-home market and any other place where people may choose to exercise, compete and improve their boxing skills.

Football

As an interface for real-ball simulation games programmed to show virtual footballs that continue the flight of thrown or kicked footballs, or close facsimiles, and interact with videogame images in real time;

As an interface for skills training activities, separate or combined with the CS football simulation games, in which the following data is captured:

Speed read-outs of thrown or kicked balls linked to a computer, digital display and any other similar electronic device;

Accuracy analysis of passes, field goal attempts and punts, graphically recreated and depicted in relation to targets, in particular virtual receivers in motion, virtual uprights, a virtual football field featuring a color-coded grid overlay between the 20 yard line and end zone, advertisers' logos and the like, typically shown on a virtual football field as well as other settings;

Distance analysis of thrown or kicked balls, graphically recreated and depicted in the context of various reference points on a virtual football field and other settings;

Player form and technique analysis that is derived from:

Tracking the arm motion and hand path of the player as quarterback (i.e. the ball's path prior to its release point) and graphically recreating and depicting that motion on-screen;

For each throw, a player's arm motion and hand path may be compared to the arm motion and hand path of select professional players as an ideal frame of reference;

Tracking the flight of thrown or kicked balls, particularly their acceleration, rotation and the like, and graphically recreating and depicting this acceleration and rotational movement in correlation with the trajectory of the throw on-screen;

For each throw or kick, making spin and trajectory calculations and graphically manifesting those calculations on-screen;

The calculations of a player's spin and trajectory for various throws or kicks may be compared alongside spin and trajectory calculations of throws or kicks by select professional players as an ideal frame of reference;

Showing defensive players' reactions to a player's ball-carrying skills with the on-screen image set in motion as if the player is advancing on the opposing team's end zone; and

In the context of utilizing CS' football simulations for purposes of marketing, advertising and promoting third-party products and services, the CS object-tracking system may be applied:

As a means to facilitate experiential marketing interactions between brands and players' interactive experiences by seamlessly placing branding elements into CS' real-ball football simulation games and skills training activities, such as having advertisers' logos appear as targets in front of virtual receivers and or as branded “Kick it Here!” animations beyond the goal-posts and as part of any other types of branding images in various other virtual locations, and awarding promotional prizes whenever players successfully hit the targets, in addition to many other promotional marketing strategies that may be implemented using this experiential sports simulation platform; and

In the context of online gaming,

As part of a real-ball, virtual fantasy football league in which players actually compete via online gaming experiences, all tied together by an avatar-based community that offers social networking features, such as player showcases called “combines”, contests and tournaments, player drafts, personalized football cards, contracts, salaries, stadium and team owners, general managers, team managers, coaches, individual and team statistics, video highlights, “Cybersports Center” broadcasts, trophies, championship rings, awards ceremonies, All-Star teams, title or “Cyber-Bowl Champions” and the like; and

As part of live promotional events and the like, during which real professional athletes and celebrities appear live via CS' online gaming portal to compete against various players, or “Cyber-athletes”, simultaneously as quarterbacks in accuracy and distance throwing contests and as kickers in field-goal and punting contests and the like; and

Uses and Benefits Derived from CS' Football Applications:

CS' real-ball object-tracking interface may make the football game-play completely realistic due to its ability to generate motion data from inside actual footballs, or close facsimiles, and process all 6 degrees of freedom in real time;

Speed, accuracy and distance feedback with graphical representations for throwing and kicking may provide players with a clear and quantifiable picture of their performances;

Arm & hand path feedback may allow players to see their throwing form and technique in a graphical way and recognize nuances in their throwing motion compared to professional standards;

Ball path and rotation feedback may allow players to see their throwing and kicking performances in an in-depth, three-dimensional way and compare them against professional standards;

Combined with arm and hand path feedback, players may be shown the cause and effect between throwing technique and performance, including how arm and wrist angle and other mechanics affect the outcome of the throw; and,

In the context of CS' football simulations being utilized for experiential marketing,

Out-of-home advertising and promotional opportunities that are fully integrated, customizable, experiential and interactive may assist sports marketers in reaching their target audiences in venue-specific ways (e.g., beer ads in sports bars and sports equipment and apparel ads in sporting goods stores).

Similar Motion-Based Technologies Used for Football Simulations

Nintendo Wii—uses a mounted optical sensor and an embedded 3-axis motion sensor in its handheld remote control, called a Wiimote (with an optional Wii Motion Plus extension for measuring rotation), which players move around in order to throw passes and interact with video-game images on-screen; and

Visual Sports Systems (“VSS”)—uses a pair of line-scan cameras that track the trajectory and speed of passes and kicks and then shows video images reacting in real time.

How CS' Tracking System Adds Unique Value Compared to its Competitors

Realism of CS' Football Game Simulations

Unlike Nintendo's Wii, CS' Smart Footballs may allow players to throw and kick using regulation-size footballs within first-person, life-size football stadium environments;

CS' multi-axis sensors (6 axes or more) embedded into real footballs, or close facsimiles, may make the interface and game-play completely realistic, much more so than the interaction offered by Nintendo's Wiimote or VSS' cameras;

Training Benefits of CS' Football Simulations

Nintendo Wii does not use real sports equipment, so it is incapable of providing useful training feedback based on actual athletic performance;

CS' performance data and in-depth analysis of each facet of a player's passes and kicks may provide more comprehensive feedback on player performance than VSS, which only measures ball speed and direction; and

Advertising Benefits of CS' Football Simulations

No other real-ball football simulation system features any type of in-game advertising opportunities, much less interactive promotional tie-ins and venue-specific targeted advertising strategies.

Markets for Cybersports' Football Simulations

Entertainment Market—sports bars, entertainment centers, museums, halls of fame, stadiums, arenas, cruise ships, casinos, resorts, movie theaters, malls, retail stores, military bases, retirement communities, college campuses, fan-fests, trade shows, corporate events, promotional events, luxury condominiums, the in-home market and any other place where people may choose to be entertained by playing real-ball virtual football; and

Fitness & Training Market—athletic training facilities, fitness centers, sports camps, hospitals, schools, colleges, pro teams, sporting goods stores, luxury condominiums, the in-home market and any other place where people may choose to exercise, compete and seek to improve their football skills.

Basketball

As an interface for real-ball simulation games programmed to show virtual basketballs that continue the flight of thrown (by way of passing or shooting) basketballs, or close facsimiles, and interact with video-game images in real time;

As an interface for skills training activities, separate or combined with the CS basketball simulation games, in which the following data is captured:

Speed read-outs of thrown balls linked to a computer, digital display and any other similar electronic device;

Accuracy analysis of passes, free throws and two- & three-point attempts, graphically recreated and depicted in relation to targets, in particular virtual teammates in motion, a virtual backboard, rim and basket, advertisers' logos and the like, typically shown on a virtual basketball court as well as other settings;

Distance analysis of thrown balls, graphically depicted in the context of various reference points on a virtual basketball court and other settings to determine the best passing and shooting techniques from various distances;

Player form and technique analysis that is derived from:

Tracking the arm motion and hand path of a player in the act of shooting (i.e. the ball's path prior to its release point) and graphically recreating and depicting that motion on-screen;

For each shot, a player's arm motion and hand path may be compared to the arm motion and hand path of select professional players as an ideal frame of reference;

Tracking the flight of balls, particularly their acceleration, rotation and the like, and graphically recreating and depicting this acceleration and rotational movement in Correlation with the trajectory of the pass or shot: on-screen;

For each pass or shot, making spin and trajectory calculations and graphically manifesting those calculations on-screen;

The calculations of a player's spin and trajectory for various passing and shooting situations may be compared alongside spin and trajectory calculations of passes and shots by select professional players as an ideal frame of reference;

Showing a defensive player's reactions to the player's ball-handling skills with the on-screen image set: in motion as if the player is advancing the ball clown the court; and

In the context of utilizing CS' basketball simulations for purposes of marketing, advertising and promoting third-party products and services, the CS object-tracking system may be applied:

As a means to facilitate experiential marketing interactions between brands and players' interactive experiences by seamlessly placing branding elements into CS' real-ball basketball simulation games and skills training activities, such as having advertisers' logos appear as targets in front of virtual baskets and teammates, and as part of any other types of branding images in various other virtual locations, and awarding promotional prizes whenever players successfully hit the targets, in addition to many other promotional marketing strategies that may be implemented using this experiential sports simulation platform; and

In the context: of online gaming,

As part of a real-ball, virtual fantasy basketball league in which players actually compete via online gaming experiences, all tied together by an avatar-based community that offers social networking features, such as a development league system, player showcases, contests and tournaments, player drafts, personalized basketball cards, con-tracts, salaries, arena and team owners, general managers, team managers, coaches, individual and team statistics, video highlights, “Cybersports Center” broadcasts, trophies, championship rings, awards ceremonies, All-Star teams and the like; and

As part of live promotional events and the like, during which real professional athletes and celebrities appear live via CS' online gaming portal to compete against various players, or “Cyber-athletes”, simultaneously, as shooters competing in three-point shooting contests or as passers competing in accuracy contests and the like; and

Uses and Benefits Derived from CS' Basketball Applications:

CS' real-ball object-tracking interface may make the basketball game-play completely realistic due to its ability to generate motion data from inside actual basketballs, or close facsimiles, and process all 6 degrees of freedom in real time;

Accuracy feedback with graphical representations for passing and shooting may provide players with a clear and quantifiable picture of their performances;

Arm & hand path feedback may allow players to see their passing and shooting form and technique in a graphical way and recognize nuances in their motion compared to professional standards;

Ball path and rotation feedback may allow players to see their passing and shooting performances in an in-depth, three-dimensional way and compare them against professional standards;

Combined with arm and hand path feedback, players may be shown the cause and effect between passing and shooting technique and performance, including how arm and wrist angle and other mechanics affect the outcome of the pass or shot; and,

In the context of CS' basketball simulations being utilized for experiential marketing,

Out-of-home advertising and promotional opportunities that are fully integrated, customizable, experiential and interactive may assist, sports marketers in reaching their target audiences in venue-specific ways (e.g., soda ads in basketball arenas and sports equipment and apparel ads in sporting goods stores).

Similar Motion-Based Technologies Used for Basketball Simulations

Nintendo Wii—uses a mounted optical sensor and an embedded 3-axis sensor in its handheld remote control, called a Wiimote (with an optional Wii Motion Plus extension for measuring rotation), which players move around in order to interact with videogame images on-screen; and

Visual Sports Systems (“VSS”)—uses a pair of line-scan cameras that track the trajectory and speed of shots and passes and then shows video images reacting in real time.

How CS' Tracking System Adds Unique Value Compared to its Competitors

Realism of CS' Basketball Game Simulations

Unlike Nintendo's Wii, CS' Smart Basketballs may allow players to pass and shoot using regulation-size basketballs within first-person, life-size basketball arena environments;

CS' multi-axis sensors (6 axes or more) embedded into real basketballs, or close facsimiles, may make the interface between object-tracking and game-play completely realistic, much more so than the interaction offered by Nintendo's Wiimote and VSS' cameras;

Training Benefits of CS' Basketball Simulations Compared to Competitors

Nintendo Wii does not use real sports equipment, so it is incapable of providing useful training feedback based on actual athletic performance;

CS' performance data and in-depth analysis of each facet of a player's passes and shots may provide more comprehensive feedback on player performance than VSS, which only measures speed and direction; and

Advertising Benefits of CS' Basketball Simulations

No other real-ball basketball simulation system features any type of in-game advertising opportunities, much less interactive promotional tie-ins and venue-specific targeted advertising strategies.

Markets for Cybersports' Basketball Simulations

Entertainment Market—sports bars, entertainment centers, museums, halls of fame, stadiums, arenas, cruise ships, casinos, resorts, movie theaters, malls, retail stores, military bases, retirement communities, college campuses, fan-fests, trade shows, corporate events, promotional events, luxury condominiums, the in-home market and any other place where people may choose to be entertained by playing real-ball virtual basketball; and

Fitness & Training Market—athletic training facilities, fitness centers, sports camps, hospitals, schools, colleges, pro teams, sporting goods stores, luxury condominiums, the in-home market and any other place where people may choose to exercise, compete and seek to improve their basketball skills.

Hockey

As an interface for real-ball simulation games programmed to show virtual hockey pucks that continue the flight of impacted hockey pucks, or close facsimiles, and interact with videogame images in real time;

As an interface for skills training activities, separate or combined with the CS hockey simulation games, in which the following data is captured:

Speed read-outs of an impacted puck linked to a computer, digital display and any other similar electronic device;

Accuracy analysis of passes and shots, graphically recreated and depicted in relation to targets, in particular in particular virtual team-mates in motion, a virtual hockey net, advertisers' logos and the like, typically shown on a virtual hockey rink as well as other settings;

Distance analysis of impacted hockey pucks, graphically depicted in the context of various reference points on a virtual hockey rink and other settings;

Player form and technique analysis that is derived from:

Tracking the movement of impacted pucks, particularly their acceleration, rotation and the like, and graphically recreating and depicting this acceleration and rotational movement in correlation with the trajectory of the pass or shot on-screen;

For or each pass or shot, making spin and trajectory calculations and graphically manifesting those calculations on-screen;

The calculations of a player's spin and trajectory for various passing and shooting situations may be compared alongside spin and trajectory calculations of passes and shots by select professional players as an ideal frame of reference;

Tracking the path of a swung hockey stick by embedding multi-axis sensors in two places, in the top (the handle) and bottom of the shaft, then translating the data and graphically recreating and depicting each swing path on-screen;

For each swing, a player's swing path may be compared to the swing path of select professional players as an ideal frame of reference;

Showing defensive and goalie reactions to a player's stick-handling skills with the on-screen image set in motion as if the player is advancing toward the opposing team's goal; and

In the context of utilizing CS' hockey simulations for purposes of marketing, advertising and promoting third-party products and services, the CS object-tracking system may be applied:

As a means to facilitate experiential marketing interactions between brands and players' interactive experiences by seamlessly placing branding elements into CS' real-ball hockey simulation games and skills training activities, such as having advertisers' logos appear as targets in front of virtual hockey sticks or the 1, 2, 3, 4 and 5 holes of a hockey net, and as part of any other types of branding images in various other virtual locations, and awarding promotional prizes when-ever players successfully hit the targets, in addition to many other promotional marketing strategies that may be implemented using this experiential sports simulation platform; and

In the context of online gaming,

As part of a real-ball, virtual fantasy hockey league in which players actually compete via online gaming experiences, all tied together by an avatar-based community that offers social networking features, such as a minor league system, player showcases, contests and tournaments, player drafts, personalized hockey cards, contracts, salaries, arenas and team owners, general managers, coaches, individual and team statistics, video highlights, “Cybersports Center” broadcasts, trophies, championship rings, awards ceremonies, All-Star teams and the like; and

As part of live promotional events and the like, during which real professional athletes and celebrities appear live via CS' online gaming portal to compete against various players, or “Cyber-athletes”, simultaneously, as shooters competing in goal-scoring contests or as passers competing in accuracy contests and the like; and

Uses and Benefits Derived from CS' Hockey Applications:

CS' real-ball object-tracking interface may make the hockey game-play completely realistic due to its ability to generate motion data from inside actual hockey pucks, or close facsimiles, and process all 6 degrees of freedom in real time;

Speed and accuracy feedback with graphical representations for passing and shooting may provide players with a clear and quantifiable picture of their performances;

Stick path feedback may allow players to see their passing and shooting form and technique in a graphical way and recognize nuances in their stick motion compared to professional standards;

Ball path and rotation feedback may allow players to see their passing and shooting performances in an in-depth, three-dimensional way and compare them against professional standards;

Combined with stick path feedback, players may be shown the cause and effect between passing and shooting technique and performance, including how swing mechanics affect the outcome of the pass or shot; and,

In the context of CS' hockey simulations being utilized for experiential marketing,

Out-of-home advertising and promotional opportunities that are fully integrated, customizable, experiential and interactive may assist sports marketers in reaching their target audiences in venue-specific ways (e.g., soda ads in hockey arenas and sports equipment and apparel ads in sporting goods stores).

Similar Motion-Based Technologies Used for Hockey Simulations

Visual Sports Systems (“VSS”)—uses a pair of line-scan cameras that track the trajectory and speed of shots and then shows video images of goalies' reactions in real time.

How CS' Tracking System Adds Unique Value Compared to its Competitors

Realism of CS' Hockey Game Simulations

CS' multi-axis sensors (6 axes or more) embedded into real hockey pucks, or close facsimiles, may make the interface between object-tracking and game-play completely realistic, much more so than the interaction offered by VSS' cameras;

Training Benefits of CS' Hockey Simulations Compared to Competitors

CS' performance data and in-depth analysis of each facet of a player's passes and shots may provide more comprehensive feedback on player performance than VSS, which only measures speed and direction; and

Advertising Benefits of CS' Hockey Simulations

No other real-puck hockey simulation system features any type of in-game advertising opportunities, much less interactive promotional tie-ins and venue-specific targeted advertising strategies.

Markets for Cybersports' Hockey Simulations

Entertainment Market—sports bars, entertainment centers, museums, halls of fame, stadiums, arenas, cruise ships, casinos, resorts, movie theaters, malls, retail stores, military bases, retirement communities, college campuses, fan-fests, trade shows, corporate events, promotional events, luxury condominiums, the in-home market and any other place where people may choose to be entertained by playing real-ball virtual hockey; and

Fitness & Training Market—athletic training facilities, fitness centers, hockey links, sports camps, hospitals, schools, colleges, pro teams, sporting goods stores, luxury condominiums, the in-home market and any other place where people may choose to exercise, compete and seek to improve their hockey skills.

Tennis

As an interface for real-ball simulation games programmed to show virtual tennis balls that continue the flight of impacted tennis balls, or close facsimiles, and interact with videogame images in real time;

As an interface for skills training activities, separate or combined with the CS tennis simulation games, in which the following data is captured:

Speed read-outs of impacted balls linked to a computer, digital display and any other similar electronic device;

Accuracy analysis of tennis shots, graphically recreated and depicted in relation to targets, in particular color-coded grid overlays on the service box and receiving side of the court for diverse shots as well as various types of match situations and the like, typically shown on a virtual tennis court as well as other settings;

Distance analysis of tennis serves and ground strokes, graphically recreated and depicted in the context of a close-up view of the service box, sidelines and end line being targeted;

Player form and technique analysis that is derived from:

Tracking the flight of impacted balls, particularly their acceleration, rotation and the like, and graphically recreating and depicting this acceleration and rotational movement in correlation with the trajectory of the serve or shot on-screen;

For each serve or shot, making spin and trajectory calculations and graphically manifesting those calculations on-screen;

The calculations of a player's spin and trajectory for various serves and shots (first serve, second serve, kick-serve, topspin, slice, drop shot, overhead and the like) may be compared alongside spin and trajectory calculations of serves and shots by select professional players as an ideal frame of reference;

Tracking the path of a swung tennis racket by embedding multi-axis sensors in two places, one at each end of the handle, then translating the data relative to virtual or real balls in motion and graphically recreating and depicting each swing path on-screen;

For each swing, a player's swing path may be compared to the swing path of select professional players as an ideal frame of reference; and,

In the context of utilizing CS' tennis simulations for purposes of marketing, advertising and promoting third-party products and services, the CS object-tracking system may be applied:

As a means to facilitate experiential marketing interactions between brands and players' interactive experiences by seamlessly placing branding elements into CS' real-ball tennis simulation games and skills training activities, such as having advertisers' logos appear as targets in front of virtual baselines and service boxes or as branded “Hit it Here!” animations placed randomly on the court and as part of any other types of branding images in various other virtual locations, and awarding promotional prizes whenever players successfully hit the targets, in addition to many other promotional marketing strategies that may be implemented using this experiential sports simulation platform; and

In the context of online gaming,

As part of a real-ball, virtual fantasy tennis league in which players actually compete via online gaming experiences, all tied together by an avatar-based community that offers social networking features, such as player showcases, contests and tournaments, purses, coaches, individual statistics, video highlights, “Cybersports Center” broadcasts, trophies, awards ceremonies, rankings and the like; and

As part of live promotional events and the like, during which real professional athletes and celebrities appear live via CS' online gaming portal to compete against various players, or “Cyber-athletes”, simultaneously, in serving accuracy and speed contests as well as ground stroke power and accuracy and the like; and

Uses and Benefits Derived from CS' Tennis Applications:

CS' real-ball object-tracking interface may make the tennis game-play completely realistic due to its ability to generate motion data from inside actual tennis balls, or close facsimiles, and process all 6 degrees of freedom in real time;

Speed and accuracy feedback with graphical representations of each may provide players with a clear and quantifiable picture of their performances;

Racket path feedback may allow players to see their swinging form and technique in a graphical way and recognize nuances in their swing motion compared to professional standards;

Ball path and rotation feedback may allow players to see their serve and ground stroke performances in an in-depth, three-dimensional way and compare them against professional standards;

Combined with racket path feedback, players may be shown the cause and effect between swing technique and performance, including how arm and wrist angle and other mechanics affect the outcome of the swing; and,

In the context of CS' tennis simulations being utilized for experiential marketing,

Out-of-home advertising and promotional opportunities that are fully integrated, customizable, experiential and interactive may assist sports marketers in reaching their target audiences in venue-specific ways (e.g., credit cards in resorts and sports equipment and apparel ads in sporting goods stores).

Similar Motion-Based Technologies Used for Tennis Simulations

Nintendo Wii—uses a mounted optical sensor and an embedded 3-axis sensor in its handheld remote control, called a Wiimote (with an optional Wii Motion Plus extension for measuring rotation), which players move around for both serves and ground strokes in order to inter-act with videogame images on-screen.

How CS' Tracking System Adds Unique Value Compared to its Competitors

Realism of CS' Tennis Game Simulations

Unlike Nintendo's Wii, CS' Smart Tennis Balls may allow players to hit serves and ground strokes using regulation-size tennis balls within first-person, life-size tennis court environments;

CS' multi-axis sensors (6 axes or more) embedded into real tennis balls, or close facsimiles, may make the interface between object-tracking and game-play completely realistic, much more so than the interaction offered by Nintendo's Wiimote;

Training Benefits of CS' Tennis Simulations Compared to Competitors

Nintendo Wii does not use real sports equipment, so it is incapable of providing useful training feedback based on actual athletic performance;

CS' performance data and in-depth analysis of each facet of a player's shots may provide more comprehensive feedback on player performance than its competitors; and

Advertising Benefits of CS' Tennis Simulations

No other real-ball tennis simulation system features any type of in-game advertising opportunities, much less interactive promotional tie-ins and venue-specific targeted advertising strategies.

Markets for Cybersports' Tennis Simulations

Entertainment Market—sports bars, entertainment centers, museums, halls of fame, stadiums, arenas, cruise ships, casinos, resorts, movie theaters, malls, retail stores, military bases, retirement communities, college campuses, fan-fests, trade shows, corporate events, promotional events, luxury condominiums, the in-home market and any other place where people may choose to be entertained by playing real-ball virtual tennis; and

Fitness & Training Market—athletic training facilities, fitness centers, country clubs, tennis centers, sports camps, hospitals, schools, colleges, pro teams, sporting goods stores, luxury condominiums, the in-home market and any other place where people may choose to exercise, compete and seek to improve their tennis skills.

Bowling

As an interface for real-ball simulation games programmed to show virtual bowling balls that continue the path of bowled bowling balls, or close facsimiles, and interact with videogame images in real time;

As an interface for skills training activities, separate or combined with the CS bowling simulation games, in which the following data is captured:

Speed read-outs of bowled balls linked to a computer, digital display and any other similar electronic device;

Accuracy analysis of bowls, graphically recreated and depicted in relation to targets, in particular virtual bowling pins, advertisers' logos and the like, typically shown in a virtual bowling lane as well as other settings;

Player form and technique analysis that is derived from:

Tracking the arm motion and hand path of a bowler (i.e. the ball's path prior to its release point) and graphically recreating and depicting that motion on-screen;

For each bowl, a player's arm motion and hand path may be compared to the arm motion and hand path of select professional players as an ideal frame of reference;

Demonstrating the cause and effect of the bowler's ball movement based on analyzing the angle and rotation of the ball at the bowler's release point.

Tracking the movement of bowled balls, particularly their acceleration, rotation and the like, and graphically recreating and depicting this acceleration and rotational movement in correlation with the trajectory of the bowl on-screen;

For each bowl, making spin and trajectory calculations and graphically manifesting those calculations on-screen;

The calculations of a bowler's spin and trajectory for various bowling situations (i.e. pin formations) may be compared alongside spin and trajectory calculations of bowls thrown by select professional bowlers as an ideal frame of reference; and

In the context of utilizing CS' bowling simulations for purposes of marketing, advertising and promoting third-party products and services, the CS object-tracking system may be applied:

As a means to facilitate experiential marketing interactions between brands and players' interactive experiences by seamlessly placing branding elements into CS' real-ball bowling simulation games and skills training activities, such as having advertisers' logos appear as targets in front of virtual bowling pins or as branded “Bowl it Here!” animations and as part of any other types of branding images in various other virtual locations, and awarding promotional prizes whenever players successfully hit the targets, in addition to many other promotional marketing strategies that may be implemented using this experiential sports simulation platform; and

In the context of online gaming,

As part of a real-ball, virtual fantasy bowling league in which players actually compete via online gaming experiences, all tied together by an avatar-based community that offers social networking features, such as player showcases, contests and tournaments, purses, coaches, individual and team statistics, video highlights, “Cybersports Center” broadcasts, trophies, championship rings, awards ceremonies, All-Star teams and the like; and

As part of live promotional events and the like, during which real professional bowlers and celebrities appear live via CS' online gaming portal to compete against various players, or “Cyber-athletes”, simultaneously in a round of bowling, a series of “difficult shot” contests and the like; and

Uses and Benefits Derived from CS' Bowling Applications:

CS' real-ball object-tracking interface may make the bowling game-play completely realistic due to its ability to generate motion data from inside actual bowling balls, or close facsimiles, and process all 6 degrees of freedom in real time;

Speed, accuracy and distance feedback with graphical representations of each may provide players with a clear and quantifiable picture of their performances;

Arm & hand path feedback may allow players to see their bowling form and technique in a graphical way and recognize nuances in their bowling motion compared to professional standards;

Ball path and rotation feedback may allow players to see their bowling performances in an in-depth, three-dimensional way and compare them against professional standards;

Combined with arm and hand path feedback, players may be shown the cause and effect between bowling technique and performance, including how arm and wrist angle and other mechanics affect the outcome of the bowl; and,

In the context of CS' bowling simulations being utilized for experiential marketing,

Out-of-home advertising and promotional opportunities that are fully integrated, customizable, experiential and interactive may assist sports marketers in reaching their target audiences in venue-specific ways (e.g., beer ads in sports bars and home electronics ads in malls).

Similar Motion-Based Technologies Used for Bowling Simulations

Nintendo Wii—uses a mounted optical sensor and an embedded 3-axis sensor in its handheld remote control, called a Wiimote (with an optional Wii Motion Plus extension for measuring rotation), which players move to bowl a virtual ball that interacts with a videogame image on-screen;

Brunswick's Virtual Bowling—uses sensors at the end of a shortened bowling lane to measure speed and direction of a bowled ball that interacts with videogame images showing the ball's impact with virtual bowling pins.

How CS' Tracking System Adds Unique Value Compared to its Competitors

Realism of CS' Bowling Simulations

Unlike Nintendo's Wii, CS' Smart Bowling Balls may allow players to bowl using regulation-size bowling balls within first-person, life-size bowling alley environments;

CS' multi-axis sensors (6 axes or more) embedded into real bowling balls, or close facsimiles, may make the interface between object-tracking and game-play completely realistic, much more so than the interaction offered by Nintendo's Wiimote and Brunswick's infrared sensors;

Training Benefits of CS' Bowling Simulations Compared to Competitors

Nintendo Wii does not use real sports equipment, so it is incapable of providing useful training feedback based on actual athletic performance;

CS' performance data and in-depth analysis of each facet of a player's shots may provide more comprehensive feedback on player performance than Brunswick, which only measures speed and direction; and

Advertising Benefits of CS' Bowling Simulations

No other real-ball bowling simulation system features any type of in-game advertising opportunities, much less interactive promotional tie-ins and venue-specific targeted advertising strategies.

Markets for Cybersports' Bowling Simulations

Entertainment Market—sports bars, bowling alleys, entertainment centers, museums, halls of fame, stadiums, arenas, cruise ships, casinos, resorts, movie theaters, malls, retail stores, military bases, retirement, communities, college campuses, fan-fests, trade shows, corporate events, promotional events, luxury condominiums, the in-home market and any other place where people may choose to be entertained by playing real-ball virtual bowling; and

Fitness & Training Market—athletic training facilities, bowling alleys, fitness centers, spoils camps, hospitals, schools, colleges, pro teams, sporting goods stores, luxury condominiums, the in-home market and any other place where people may choose to exercise, compete and seek to improve their bowling skills.

Lacrosse

As an interface for real-ball simulation games programmed to show virtual lacrosse balls that continue the flight of thrown lacrosse balls, or close facsimiles, and interact with videogame images in real time;

As an interface for skills training activities, separate or combined with the CS lacrosse simulation games, in which the following data is captured:

Speed read-outs of thrown balls linked to a computer, digital display and any other similar electronic device;

Accuracy analysis of passes and shots, graphically recreated and depicted in relation to targets, in particular virtual teammates in motion, a virtual lacrosse net, advertisers' logos and the like, typically shown on a virtual lacrosse field as well as other settings;

Distance analysis of thrown balls, graphically depicted in the context of various reference points on a virtual lacrosse field and other set-tings;

Player form and technique analysis that: is derived from:

Tracking the flight of thrown balls, particularly their acceleration, rotation and the like, and graphically recreating and depicting this acceleration and rotational movement in correlation with the trajectory of the pass or shot on-screen;

For each pass or shot, making spin and trajectory calculations and graphically manifesting those calculations on-screen;

The calculations of a player's spin and trajectory for various passing and shooting situations may be compared alongside spin and trajectory calculations of passes or shots by select professional players as an ideal frame of reference;

Tracking the stick path of a player (i.e. the ball's path prior to its release point) by embedding multi-axis sensors in the stick handle, then translating the data relative to the ball in the pocket and graphically recreating and depicting this stick motion on-screen;

For each throw, a player's stick motion may be compared to the motion of select professional players as an ideal frame of reference;

Showing defensive and goalie reactions to a player's stick-handling skills with the on-screen image set in motion as if the player is advancing toward the opposing team's goal; and

In the context of utilizing CS' lacrosse simulations for purposes of marketing, advertising and promoting third-party products and services, the CS object-tracking system may be applied:

As a means to facilitate experiential marketing interactions between brands and players' interactive experiences by seamlessly placing branding elements into CS' real-ball lacrosse simulation games and skills training activities, such as having advertisers' logos appear as targets in front of virtual lacrosse sticks and goals and as part of any other types of branding images in various other virtual locations, and awarding promotional prizes whenever players successfully hit the targets, in addition to many other promotional marketing strategies that may be implemented using this experiential sports simulation platform; and

In the context of online gaming,

As part of a real-ball, virtual fantasy lacrosse league in which players actually compete via online gaming experiences, all tied together by an avatar-based community that offers social networking features, such as a minor league system, player showcases, contests and tournaments, player drafts, personalized lacrosse cards, contracts, salaries, arena and team owners, general managers, team managers, coaches, individual and team statistics, video highlights, “Cybersports Center” broadcasts, trophies, awards ceremonies, All-Star teams and the like; and

As part of live promotional events and the like, during which real professional athletes and celebrities appear live via CS' online gaming portal to compete against various players, or “Cyber-athletes”, simultaneously, as shooters competing in goal-scoring contests and passers competing in accuracy and distance throwing contests and the like; and

Uses and Benefits Derived from CS' Lacrosse Applications:

CS' real-ball object-tracking interface may make the lacrosse game-play completely realistic due to its ability to generate motion data from inside actual lacrosse balls, or close facsimiles, and process all 6 degrees of freedom in real time;

Speed, accuracy and distance feedback with graphical representations for shooting and passing may provide players with a clear and quantifiable picture of their performances;

Stick path feedback may allow players to see their throwing form and technique in a graphical way and recognize nuances in their throwing motion compared to professional standards;

Ball path and rotation feedback may allow players to see their throwing performances in an in-depth, three-dimensional way and compare them against professional standards;

Combined with stick path feedback, players may be shown the cause and effect between throwing technique and performance, including how mechanics affect the outcome of the pass or shot;

In the context of CS' lacrosse simulations being utilized for experiential marketing,

Out-of-home advertising and promotional opportunities that are fully integrated, customizable, experiential and interactive may assist sports marketers in reaching their target audiences in venue-specific ways (e.g., beer ads in sports bars and sports equipment and apparel ads in sporting goods stores).

Similar Motion-Based Technologies Used for Lacrosse Simulations

None are currently on the market.

How CS' Tracking System Adds Unique Value Compared to its Competitors

Realism of CS' Lacrosse Game Simulations

CS' multi-axis sensors (6 axes or more) embedded into real lacrosse balls, or close facsimiles, may make the interface between object-tracking and game-play completely realistic, much more so than its competitors;

Training Benefits of CS' Lacrosse Simulations

CS' performance data and in-depth analysis of each facet of a player's passes and shots may provide more comprehensive feedback on player performance than its competitors; and

Advertising Benefits of CS' Lacrosse Simulations

No other real-ball lacrosse simulation system features any type of in-game advertising opportunities, much less interactive promotional tie-ins and venue-specific targeted advertising strategies.

Markets for Cybersports' Lacrosse Simulations

Entertainment Market—sports bars, entertainment centers, museums, halls of fame, stadiums, arenas, cruise ships, casinos, resorts, movie theaters, malls, retail stores, military bases, retirement communities, college campuses, fan-fests, trade shows, corporate events, promotional events, luxury condominiums, the in-home market and any other place where people may choose to be entertained by playing real-ball virtual lacrosse; and

Fitness & Training Market—athletic training facilities, fitness centers, sports camps, hospitals, schools, colleges, pro teams, sporting goods stores, luxury condominiums, the in-home market and any other place where people may choose to exercise, compete and seek to improve their lacrosse skills.

Cricket

As an interface for real-ball simulation games programmed to show virtual cricket balls that continue the flight of bowled or batted cricket balls, or close facsimiles, and interact with videogame images in real time;

As an interface for skills training activities, separate or combined with the CS cricket simulation games, in which the following data is captured:

Speed read-outs of thrown or batted balls linked to a computer, digital display and any other similar electronic device;

Accuracy analysis of bowls, throws and batted balls, graphically recreated and depicted in relation to targets, in particular a virtual catcher's mitt, wickets, advertisers' logos, highlighted areas of the field for practicing different bat swing techniques and the like, typically shown on a virtual cricket field as well as other settings;

Distance analysis of thrown or batted balls, graphically depicted in the context of various reference points on a virtual cricket: ground, in particular the pitch, close-infield, infield, outfield and boundary, as well as other settings;

Player form and technique analysis that is derived from:

Tracking the arm motion and hand path of a bowler or fielder (i.e. the ball's path prior to its release point) and graphically recreating and depicting that motion on-screen;

For each bowl or throw, a player's arm motion and hand path may be compared to the arm motion and hand path of select professional players as an ideal frame of reference;

Tracking the flight of thrown balls, particularly their acceleration, rotation and the like, and graphically recreating and depicting this acceleration and rotational movement in correlation with the trajectory of the bowl or throw on-screen;

For each bowl or throw, making spin and trajectory calculations and graphically manifesting those calculations on-screen;

The calculations of a bowler's spin and trajectory for various types of bowls may be compared alongside spin and trajectory calculations of bowls thrown by select professional bowlers as an ideal frame of reference;

Tracking the path of a swung bat by embedding multi-axis sensors in two places, the bat handle and barrel, then translating the data relative to virtual or real bowls and graphically recreating and depicting each swing path on-screen;

For each swing, a player's swing path may be compared to the swing path of select professional players as an ideal frame of reference; and,

In the context of utilizing CS' cricket simulations for purposes of marketing, advertising and promoting third-party products and services, the CS object-tracking system may be applied:

As a means to facilitate experiential marketing interactions between brands and players' interactive experiences by seamlessly placing branding elements into CS' real-ball cricket simulation games and skills training activities, such as having advertisers' logos appear as targets in front of virtual cricket gloves and wickets or as branded “Hit it Here!” animations beyond the boundary wall and as part of any other types of branding images in various other virtual locations, and awarding promotional prizes whenever players successfully hit the targets, in addition to many other promotional marketing strategies that may be implemented using this experiential sports simulation platform; and

In the context of online gaming,

As part of a real-ball, virtual fantasy cricket league in which players actually compete via online gaming experiences, all tied together by an avatar-based community that offers social networking features, such as player showcases, contests and tournaments, player drafts, contracts, salaries, stadium and team owners, general managers, team managers, bowling and batting coaches, individual and team statistics, video highlights, “Cybersports Center” broadcasts, trophies, awards ceremonies, All-Star teams and the like; and

As part of live promotional events and the like, during which real professional athletes and celebrities appear live via CS' online gaming portal to compete against various players, or “Cyber-athletes”, simultaneously, as batsmen competing in distance hitting contests, as bowlers bowling to Cyber-athlete batsmen, or as bowlers and field players competing in accuracy and distance throwing contests and the like.

Uses and Benefits Derived from CS' Cricket Applications:

CS' real-ball object-tracking interface may make the cricket game-play completely realistic due to its ability to generate motion data from inside actual cricket balls, or close facsimiles, and process all 6 degrees of freedom in real time;

Speed, accuracy and distance feedback with graphical representations for throwing, bowling and batting may provide players with a clear and quantifiable picture of their performances;

Arm & hand path feedback may allow players to see their bowling/throwing form and technique in a graphical way and recognize nuances in their throwing motion compared to professional standards;

Ball path and rotation feedback may allow players to see their bowling/throwing performances in an in-depth, three-dimensional way and compare them against professional standards;

Combined with arm and hand path feedback, players may be shown the cause and effect between bowling/throwing technique and performance, including how finger placement and pressure on the ball, arm and wrist angle and other mechanics affect: the outcome of the throw or pitch;

Bat path feedback may allow players to see their hitting form and technique in a graphical way and compare it to professional standards;

Combined with speed, direction and distance feedback on the player's hits, the player may be shown the cause and effect between hitting technique and performance, including how timing and rotation of the wrists, direction and angle of the bat head through point of contact and other factors collectively affect the outcome of the swing; and,

In the context of CS' cricket simulations being utilized for experiential marketing,

Out-of-home advertising and promotional opportunities that are fully integrated, customizable, experiential and interactive may assist sports marketers in reaching their target audiences in venue-specific ways (e.g., beer ads in sports bars and sports equipment and apparel ads in sporting goods stores).

Similar Motion-Based Technologies Used for Cricket Simulations

EDH Sport (“EDH”)—uses a microwave-emitting pad to detect the motion and speed of bowls as well as ball flight characteristics.

How CS' Tracking System Adds Unique Value Compared to its Competitors

Realism of CS' Cricket Game Simulations

CS' multi-axis sensors (6 axes or more) embedded into real cricket balls, or close facsimiles, may make the interface between object-tracking and game-play completely realistic, more so than the interaction offered by EDH Sport's microwave technology;

Training Benefits of CS' Cricket Simulations

CS' performance data and in-depth analysis of each facet of a player's bowls, throws and hits may provide more comprehensive feedback on player performance than EDH; and

Advertising Benefits of CS' Cricket Simulations

No other real-ball cricket simulation system features any type of in-game advertising opportunities, much less interactive promotional tie-ins and venue-specific targeted advertising strategies.

Markets for Cybersports' Cricket Simulations

Entertainment Market—sports bars, entertainment centers, museums, halls of fame, cricket grounds, stadiums, arenas, cruise ships, casinos, resorts, movie theaters, malls, retail stores, military bases, retirement communities, college campuses, fan-fests, trade shows, corporate events, promotional events, luxury condominiums, the in-home market and any other place where people may choose to be entertained by playing real-ball virtual cricket; and

Fitness & Training Market—athletic training facilities, fitness centers, sports camps, hospitals, schools, colleges, pro teams, sporting goods stores, luxury condominiums, the in-home market and any other place where people may choose to exercise, compete and seek to improve their cricket skills.

Rugby

As an interface for real-ball simulation games programmed to show virtual rugby balls that continue the flight of thrown or kicked rugby balls, or close facsimiles, and interact with videogame images in real time;

As an interface for skills training activities, separate or combined with the CS rugby simulation games, in which the following data is captured:

Speed read-outs of thrown or kicked balls linked to a computer, digital display and any other similar electronic device;

Accuracy analysis of passes, kick-offs, attacking kicks, field goals, penalty goals and conversion goal attempts, graphically recreated and depicted in relation to targets, in particular virtual teammates in motion, uprights, advertisers' logos, a rugby field with color-coded grid overlays designed for diverse attacking kick situations, as well as other types of situations and settings

Distance analysis of thrown or kicked balls, graphically depicted in the context of various reference points on a virtual rugby field and other settings; and

Player form and technique analysis that is derived from:

Tracking the arm motions and hand paths of a player (i.e. the ball's path prior to its release point) and graphically recreating and depicting that motion on-screen;

For each pass, a player's arm motions and hand paths may be compared to the arm motions and hand paths of select professional players as an ideal frame of reference;

Tracking the flight of thrown or kicked balls, particularly their acceleration, rotation and the like, and graphically recreating and depicting this acceleration and rotational movement in correlation with the trajectory of the throw or kick on-screen;

For each throw or kick, making spin and trajectory calculations and graphically manifesting those calculations on-screen;

The calculations of a player's spin and trajectory for various passing and kicking situations may be compared alongside spin and trajectory calculations of passes or kicks by select professional players as an ideal frame of reference;

Showing defensive players' reactions to a player's ball-carrying skills with the on-screen image set in motion as if the player is advancing on the opposing team's in-goal area; and

In the context of utilizing CS' rugby simulations for purposes of marketing, advertising and promoting third-party products and services, the CS object-tracking system may be applied:

As a means to facilitate experiential marketing interactions between brands and players' interactive experiences by seamlessly placing branding elements into CS' real-ball rugby simulation games and skills training activities, such as having advertisers' logos appear as targets in front of virtual players' hands or as branded “Kick it Here!” animations beyond the uprights and as part of any other types of branding images in various other virtual locations, and awarding promotional prizes whenever players successfully hit the targets, in addition to many other promotional marketing strategies that may be implemented using this experiential sports simulation platform; and

In the context of online gaming,

As part of a real-ball, virtual fantasy rugby league in which players actually compete via online gaming experiences, all tied together by an avatar-based community that offers social networking features, such as player showcases, contests and tournaments, player drafts, contracts, salaries, stadium and team owners, general managers, team managers, coaches, individual and team statistics, video highlights, “Cybersports Center” broadcasts, trophies, championship rings, awards ceremonies, All-Star teams and the like; and

As part of live promotional events and the like, during which real professional athletes and celebrities appear live via CS' online gaming portal to compete against various players, or “Cyber-athletes”, simultaneously, as kickers competing in contests that include field goal, penalty goal and conversion goal attempts and the like.

Uses and Benefits Derived from CS' Rugby Applications:

CS' real-ball object-tracking interface may make the rugby game-play completely realistic due to its ability to generate motion data from inside actual rugby balls, or close facsimiles, and process all 6 degrees of freedom in real time;

Speed, accuracy and distance feedback with graphical representations for passing and kicking may provide players with a clear and quantifiable picture of their performances;

Arm & hand path feedback may allow players to see their passing form and technique in a graphical way and recognize nuances in their passing motion compared to professional standards;

Ball path and rotation feedback may allow players to see their passing and kicking performances in an in-depth, three-dimensional way and then compare them against professional standards;

Combined with arm and hand path feedback, players may be shown the cause and effect between passing technique and performance, including how arm and wrist angle and other mechanics affect the outcome of the pass; and,

In the context of CS' rugby simulations being utilized for experiential marketing,

Out-of-home advertising and promotional opportunities that are fully integrated, customizable, experiential and interactive may assist sports marketers in reaching their target audiences in venue-specific ways (e.g., beer ads in spoils bars and sports equipment and apparel ads in sporting goods stores).

Similar Motion-Based Technologies Used for Rugby Simulations

None are currently on the market.

How CS' Tracking System Adds Unique Value Compared to its Competitors

Realism of CS' Rugby Game Simulations

CS' multi-axis sensors (6 axes or more) embedded into real rugby balls, or close facsimiles, may make the interface between object-tracking and game-play completely realistic, much more so than the its competitors;

Training Benefits of CS' Rugby Simulations

CS' performance data and in-depth analysis of each facet of a player's passes and kicks may provide more comprehensive feedback on player performance than its competitors; and

Advertising Benefits of CS' Rugby Simulations

No other real-ball rugby simulation system features any type of in-game advertising opportunities, much less interactive promotional tie-ins and venue-specific targeted advertising strategies.

Markets for Cybersports' Rugby Simulations

Entertainment Market—sports bars, entertainment centers, museums, halls of fame, stadiums, arenas, cruise ships, casinos, resorts, movie theaters, malls, retail stores, military bases, retirement communities, college campuses, fan-fests, trade shows, corporate events, promotional events, luxury condominiums, the in-home market and any other place where people may choose to be entertained by playing real-ball virtual rugby; and

Fitness & Training Market—athletic training facilities, fitness centers, sports camps, hospitals, schools, colleges, pro teams, sporting goods stores, luxury condominiums, the in-home market and any other place where people may choose to exercise, compete and seek to improve their rugby skills.

Softball

As an interface for real-ball simulation games programmed to show virtual softballs that continue the flight of pitched or batted softballs, or close facsimiles, and interact with videogame images in real time;

As an interface for skills training activities, separate or combined with the CS softball simulation games, in which the following data is captured:

Speed read-outs of thrown or batted balls linked to a computer, digital display and any other similar electronic device;

Accuracy analysis of pitches and throws, graphically recreated and depicted in relation to targets, in particular a virtual catcher's mitt, strike zone, cut-off man, first baseman's mitt or advertisers' logos and the like, typically shown on a virtual softball field as well as other settings;

Distance analysis of thrown or batted balls, graphically depicted in the context of various reference points on a virtual softball field and other settings;

Player form and technique analysis that is derived from:

Tracking the arm motion and hand path of a pitcher or fielder (i.e. the ball's path prior to its release point) and graphically recreating and depicting that motion on-screen;

For each pitch or throw, a player's arm motion and hand path may be compared to the arm motion and hand path of select college and Olympic players as an ideal frame of reference;

Tracking the flight of thrown balls, particularly their acceleration, rotation and the like, and graphically recreating and depicting this acceleration and rotational movement in correlation with the trajectory of the pitch or throw on-screen;

For each pitch, making spin and trajectory calculations and graphically manifesting those calculations on-screen;

The calculations of a pitcher's spin and trajectory for various pitches (fastball, changeup, drop pitch and the like) may be compared alongside spin and trajectory calculations of pitches thrown by select college and Olympic pitchers as an ideal frame of reference;

Tracking the path of a swung bat by embedding multi-axis sensors in two places, the bat handle and barrel, then translating the data relative to virtual or real pitches and graphically recreating and depicting each swing path on-screen;

For each swing, a player's swing path may be compared to the swing path of select college and Olympic players as an ideal frame of reference; and,

In the context of utilizing CS' softball simulations for purposes of marketing, advertising and promoting third-party products and services, the CS object-tracking system may be applied:

As a means to facilitate experiential marketing interactions between brands and players' interactive experiences by seamlessly placing branding elements into CS' real-ball softball simulation games and skills training activities, such as having advertisers' logos appear as targets in front of virtual softball gloves and mitts or as branded “Hit it Here!” animations beyond the outfield wall and as part of any other types of branding images in various other virtual locations, and awarding promotional prizes whenever players successfully hit the targets, in addition to many other promotional marketing strategies that may be implemented using this experiential sports simulation platform; and

In the context of online gaming,

As part of a real-ball, virtual fantasy softball league in which players actually compete via online gaming experiences, all tied together by an avatar-based community that offers social networking features, such as a minor league system, player showcases, contests and tournaments, player drafts, personalized softball cards, contracts, salaries, stadium and team owners, general managers, team managers, pitching and batting coaches, individual and team statistics, video highlights, “Cybersports Center” broadcasts, trophies, championship rings, awards ceremonies, All-Star teams and the like; and

As part of live promotional events and the like, during which top athletes and celebrities appear live via CS' online gaming portal to compete against various players, or “Cyber-athletes”, simultaneously, as hitters competing in Home Run Derby contests, as pitchers throwing to Cyber-athlete hitters, or as pitchers and field players competing in accuracy and distance throwing contests and the like.

Uses and Benefits Derived from CS' Softball Applications:

CS' real-ball object-tracking interface may make the softball game-play completely realistic due to its ability to generate motion data from inside actual softballs, or close facsimiles, and process all 6 degrees of freedom in real time;

Speed, accuracy and distance feedback with graphical representations for throwing, pitching and hitting may provide players with a clear and quantifiable picture of their performances;

Arm & hand path feedback may allow players to see their pitching/throwing form and technique in a graphical way and recognize nuances in their throwing motion compared to professional standards;

Ball path and rotation feedback may allow players to see their pitching/throwing performances in an in-depth, three-dimensional way and compare them against professional standards;

Combined with arm and hand path feedback, players may be shown the cause and effect between pitching/throwing technique and performance, including how finger placement and pressure on the ball, arm and wrist angle and other mechanics affect the outcome of the throw or pitch;

Bat path feedback may allow players to see their hitting form and technique in a graphical way and compare it to professional standards;

Combined with speed, direction and distance feedback on the player's hits, the player may be shown the cause and effect between hitting technique and performance, including how timing and rotation of the wrists, direction and angle of the bat head through point of contact and other factors collectively affect the outcome of the swing; and,

In the context of CS' softball simulations being utilized for experiential marketing,

Out-of-home advertising and promotional opportunities that are fully integrated, customizable, experiential and interactive may assist sports marketers in reaching their target audiences in venue-specific ways (e.g., sports drink ads in fitness centers and sports equipment and apparel ads in sporting goods stores).

Similar Motion-Based Technologies Used for Softball Simulations

None are currently on the market.

How CS' Tracking System Adds Unique Value Compared to its Competitors

Realism of CS' Softball Game Simulations

CS' multi-axis sensors (6 axes or more) embedded into real softballs, or close facsimiles, may make the interface between object-tracking and game-play completely realistic, much more so than its competitors;

Training Benefits of CS' Softball Simulations

CS' performance data and in-depth analysis of each facet of a player's pitches, throws and hits may provide more comprehensive feedback on player performance than its competitors; and

Advertising Benefits of CS' Softball Simulations

No other real-ball softball simulation system features any type of in-game advertising opportunities, much less interactive promotional tie-ins and venue-specific targeted advertising strategies.

Markets for Cybersports' Softball Simulations

Entertainment Market—sports bars, entertainment centers, museums, halls of fame, stadiums, arenas, cruise ships, casinos, resorts, movie theaters, malls, retail stores, military bases, retirement communities, college campuses, fan-fests, trade shows, corporate events, promotional events, luxury condominiums, the in-home market and any other place where people may choose to be entertained by playing real-ball virtual softball; and

Fitness & Training Market—athletic training facilities, fitness centers, sports camps, hospitals, schools, colleges, pro teams, sporting goods stores, luxury condominiums, the in-home market and any other place where people may choose to exercise, compete and seek to improve their softball skills.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application-specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method comprising:
embedding a plurality of three-axis motion sensors within a single piece of user sports equipment, wherein each of the plurality of sensors provides a continuous stream of relative motion data for each axis;
disposing the plurality of three-axis motion sensors so that none of the axes are aligned;
connecting the disposed motion sensors to a processor, and powering the sensors and the processor so that the processor receives the relative motion data;
converting the relative motion data into a six or more axis representation of the motion of the single piece of sports equipment; and
communicating the six or more axis representation to a multimedia facility.

2. The method of claim 1, wherein the plurality of sensors consists of four three-axis motion sensors, and wherein disposing the plurality of axis motion sensors comprises positioning the four sensors at the vertices of a regular tetrahedron.

3. The method of claim 1, wherein the plurality of three-axis motion sensors is identical except for commercial manufacturing variations.

4. The method of claim 1, wherein disposing the plurality of three-axis motion sensors comprises mounting each of the plurality of three-axis motion sensors to separate printed circuit boards.

5. The method of claim 1, wherein disposing the plurality of three-axis motion sensors comprises mounting each of the plurality of three-axis sensors to a single flexible circuit and fixturing the flexible circuit to ensure that each axis of each of the plurality of motion sensors is not parallel to and not perpendicular to any of the axes of any other of the plurality of motion sensors.

6. The method of claim 1, wherein receiving the relative motion data comprises sampling each continuous stream of relative motion data at least sixteen times per second.

7. The method of claim 1, wherein converting the relative motion data into a six or more axis representation of the motion of the single piece of sports equipment includes performing differential axis measurement.

8. A method comprising:
providing a networked computing facility with a multimedia interface for receiving, using wireless communication, a consolidated continuous stream of relative motion data from a plurality of three-axis motion sensors that are embedded in a single piece of user sports equipment, wherein the three-axis sensors are disposed so that none of the axes are aligned;
presenting a visualization of the sports equipment in the multimedia interface, wherein the visualized sports equipment follows a determined path based on the consolidated motion data stream; and
presenting a visualization of an athlete in the multimedia interface, wherein the athlete visualization is adapted to interact with the visualized single piece of sports equipment, and wherein the interaction is based on a simulation model of the athlete's interaction with real sports equipment.

9. The method of claim 8, wherein the plurality of sensors consists of four three-axis motion sensors, and wherein disposing the plurality of three-axis motion sensors consists of positioning the four sensors at the vertices of a regular tetrahedron.

10. The method of claim 8, wherein receiving the relative motion data comprises sampling each continuous stream of relative motion data at least sixteen times per second.

11. The method of claim 8, wherein converting the relative motion data into a six or more axis representation of the motion of the sports equipment includes performing differential axis measurement.

12. The method of claim 8, wherein the visualized interaction between the visualized sports equipment and the visualized athlete is derived using inverse kinematics simulation.

13. The method of claim 8, wherein the athlete is a professional athlete, and wherein the visualization of the professional athlete is based on an association of the professional athlete simulation model and video images of the professional athlete interacting with real sports equipment.

14. The method of claim 8, wherein the consolidated continuous motion stream consists of at least twelve axes of motion data.

15. The method of claim 8, further including determining a performance ranking associated with the visualized sports equipment based on the athlete's simulated interaction with the visualized sports equipment.

16. The method of claim 15, further including communicating the ranking to a web server and recording the ranking in a secure-access participant ranking web page.

17. The method of claim 8, further including determining a subset of the rankings that represents top performers and presenting the subset on a public-access participant ranking web page.

18. A system comprising:
a plurality of three-axis motion sensors embedded within a single piece of user sports equipment, the three-axis motion sensors for sensing motion of the single piece of user sports equipment and providing a continuous stream of relative motion data;
a printed circuit board assembly forming a regular tetrahedron shape, wherein the plurality of three-axis motion sensors are disposed at the vertices of the regular tetrahedron;
a processor for sampling the continuous stream of relative motion data from the plurality of three-axis motion sensors and for converting the relative motion data into a twelve or more axis representation of the motion of the piece of user sports equipment; and
a multimedia facility for receiving the twelve or more axis representation of the motion and producing a visualization of the motion of the single piece of user sports equipment.

19. The system of claim 18, wherein the visualization of the motion of the single piece of user sports equipment is projected based in part on a subset of data provided by the plurality of three-axis motion sensors.

20. The system of claim 18, wherein the plurality of three-axis motion sensors consists of four substantially identical sensors.
